(19) United States
(12) Patent Application Publication
(10) Pub. No.: US 2023/0368200 A1
(43) Pub. Date: Nov. 16, 2023

(54) SYSTEMS AND METHODS FOR GENERATING VIRTUAL PAYMENT OBJECTS FOR PREAPPROVED EXPENSES

(71) Applicant: Coupa Software Incorporated, San Mateo, CA (US)

(72) Inventors: Himica Kumar, San Mateo, CA (US); Daniel Benson, San Clemente, CA (US); Nikki Gupta, San Mateo, CA (US); Mochen Liu, San Francisco, CA (US); Terry Eaton, Cincinnati, OH (US); Ketan Darji, Pune (IN); Thomas Klein, Strasbourg (FR); Mikin Faldu, San Ramon, CA (US); Rohit Jalisatgi, San Ramon, CA (US)

(21) Appl. No.: 18/315,283

(22) Filed: May 10, 2023

Related U.S. Application Data
(60) Provisional application No. 63/340,826, filed on May 11, 2022.

(51) Int. Cl. G06Q 20/40; G06Q 20/06

(52) U.S. Cl. CPC G06Q 20/40; G06Q 20/065

(57) ABSTRACT

A virtual compute instance that is communicatively coupled to a storage device comprising a database. In an embodiment, a method queries an expense pre-approval application to obtain a set of expense documents from a first computer associated with a first account that is digitally linked to a credit line account and receives the set of expense documents. The expense pre-approval application may be one of a plurality of federated applications hosted using a multi-tenant distributed computing system that comprises the virtual compute instance. The method determines expense data comprising a type of expense document, time of spend, kind of expense, and a plurality of expense charges, for each document in the set of expense documents. Based on the type of document of each expense document in the set of expense documents, the method identifies a payment gateway among a plurality of payment gateways. Each payment gateway executes a plurality of programmatic payment rails that the first account can access. Using the payment gateway, preapproved expense charges are evaluated based on the expense data. The method includes creating and storing in the database, a plurality of expense payment objects associated with the preapproved expense charges when a first account database table associated with the credit line account of the first account matches with a second account database table of the payment gateway, and automatically applying the plurality of expense payment objects to reduce account balances of one or more preapproved spending amounts.

### BENEFIT CLAIM

This application claims the benefit under 35 U.S.C. § 119(e) of application 63/340,826, filed 11 May 2022, the entire contents of which are hereby incorporated by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright or rights whatsoever. © 2022 Coupa Software Incorporated.

### TECHNICAL FIELD

One technical field of the present disclosure is object-oriented distributed computer systems with automated database management capabilities. Another technical field is federated e-procurement systems that include expense management software and automated network links to other computer systems capable of executing payment transactions.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by their inclusion in this section.

Digital relational databases now are widely used to store, manage, and control the flow of information in business enterprises, with integration into a variety of practical applications. One example application is employee expense management. In many business enterprises, employees or contractors incur external expenses in the course and scope of employment and are entitled to reimbursement, from the enterprise, for those expenses. To manage the collection, review, and approval of expense information, enterprises use expense management software, linked to relational databases.

For example, travel costs are a significant portion of employee expenses for some enterprises and their employees. Business travel can involve costs of thousands of dollars per trip and hundreds of thousands of dollars per employee per year. Therefore, to manage the creation or collection, review, and approval of travel expense information, enterprises use travel expense management software, linked to relational databases. In some cases, but not all, general expense management is linked to travel management.

Some enterprises use virtual payment cards for employee purchases. In the past, enterprises would issue individual plastic payment cards to individual employees, each card is associated with a different payment account, or sometimes with a centralized account for the enterprise. In another example, an enterprise could have required employees to pay for business expenses with their own funds, payment cards, or other payment instruments, and obtain reimbursement later. That process was inconvenient and unpopular for high-cost items such as airline tickets. Today, virtual payment cards are more common and consist of a card number and sometimes other credentials that can be presented in payment card networks to accomplish a payment. For example, users using virtual payment cards are issued purchase orders (POs) for travel and expense. However, in present practice, virtual payment cards are managed independently of expense reporting applications. When a trip or event occurs, the employee must present a plastic card or a virtual card at the time of purchase, cost, or expense. After the trip or event, reconciliation is required to associate payment card charges to expense report line items. Extensive time and indirect costs can be involved to accomplish the reconciliation. For example, users using the virtual payment cards that are issued through the POs involve a complex manner of reconciliation of fund usage on expenses and corresponding expense reports. This causes extra time and effort in reconciling preapproved amounts, budgets, and actuals. Enterprises desire a better way to link virtual cards to expense reports to facilitate faster, more efficient reconciliation. In technical terms, enterprises need improved distributed database applications that can automatically generate programmatic objects as needed, populate the objects, and reconcile different classes of objects against others.

### SUMMARY

The appended claims may serve as a summary of the invention.

### BRIEF DESCRIPTION OF THE DRAWINGS

In the drawings:

FIG. 1 illustrates a distributed computer system with which one embodiment can be implemented;

FIG. 2 is a flow diagram depicting an example method for creating virtual payment objects for preapproved expense charges, according to an embodiment;

FIG. 3 illustrates a process flow or algorithm that can be programmed to generate virtual payment objects and expense reports with reconciliation line items for credit line account reconciliation, according to an embodiment;

FIG. 4 illustrates a portion of a graphical user interface showing the management of virtual card payments on expense reports, according to an embodiment;

FIG. 5 illustrates a portion of a graphical user interface showing all preapproved expense charges based on a type of document, according to an embodiment;

FIG. 6 illustrates a schema of programmatic objects for expense pre-approval and pay expense pre-approval, according to an embodiment;

FIG. 7 illustrates a flow of digital data to accomplish the automatic reconciliation of virtual card charges to expense preapprovals, according to an embodiment;

FIG. 8 illustrates an example of the automatic allocation of payments for pre-approved expenses, expense reports, and expense report lines, via the creation of multiple programmatic objects, according to an embodiment;

FIG. 9 illustrates an example of programmatic data flows relating to automated reconciliation against an ERP system;

FIG. 10 illustrates a computer system with which one embodiment could be implemented.

### DETAILED DESCRIPTION

In the following description, for clarity, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions, at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

An embodiment can be used in a distributed computer system comprising components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. Other arrangements may include fewer or different components, and the division of work between the components may vary depending on the arrangement.

The drawing figures and all of the descriptions and claims in this disclosure are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

Each flow diagram or written description of an algorithm herein is intended as an illustration at the functional level at which skilled persons, in the art to which this disclosure pertains, communicate with one another to describe, and implement algorithms using programming. The flow diagrams are not intended to illustrate every instruction, method object, or sub-step that would be needed to program every aspect of a working program, but are provided at the same functional level of illustration that is normally used at the high level of skill in this art to communicate the basis of developing working programs.

Embodiments are described in sections according to the following outline:
1.0 GENERAL OVERVIEW
2.0 STRUCTURAL & FUNCTIONAL OVERVIEW
3.0 EXAMPLE GRAPHICAL USER INTERFACE
4.0 EXAMPLE PRE-APPROVAL EXPENSE MODEL
5.0 IMPLEMENTATION EXAMPLE—HARDWARE OVERVIEW

### 1.0 GENERAL OVERVIEW

Embodiments are programmed to automatically determine preapproved expense charges and generate virtual payment cards that apply to each type of preapproved expense charge. Embodiments disclose a virtual compute instance that evaluates one or more spend amounts and approves them as preapproved expense charges. The application of pre-approvals makes spending easier and more manageable, avoiding the complexity of making multiple payments and requesting reimbursements.

The virtual compute instance may be configured to procure expense documents and expense records from various vendors and suppliers to inspect various types of spend document line descriptions and items. For example, an employee can submit various types of purchase orders, and invoices collated from different vendors and suppliers who estimate spending (“spend”) amounts that may be incurred for travel bookings, travel planning, and reservations. The virtual compute instance evaluates whether the employee is associated with a credit line account. Based on the type of expense document or expense record uploaded by the employee, the virtual compute instance analyzes multiple line descriptions, item descriptions, categorization, and other line items from the documents. Based on the analysis, the virtual compute instance evaluates the kind of expense, expense charges, the reason for expenses, time of spend towards various expenses, and other expense-related information. For example, the embodiments evaluate different times when the employee may incur various expenses for travel planning and/or bookings, scheduling, reservations, or arrangements. The employee can submit the POs, the invoices, and the spend amounts, along with descriptions of incurring such spends, to the accounts department for approval. From the analysis of various descriptions of document lines and document types, the virtual compute instance identifies a payment gateway that may be optimal among different payment gateways for the employee's credit line account to access payment rails directly and automatically. Through the payment rails, multiple expense charges incurred by the employee are evaluated. In an embodiment, the evaluated multiple expense charges are approved as “preapproved” by, for example, the account's department. The multiple preapproved expense charges may be used to create a plurality of expense payment objects. The expense payment objects may include, for example, virtual cards. The expense payment objects are capable of being applied to preapproved expense charges or spend. In an embodiment, the expense payment objects may be created when the account of the employee having the credit line matches with an account of the payment gateway providing the accessibility to the payment rail. The creation of virtual cards may be applied to reduce the account balances of the employee towards preapproved expense charges or spend amounts.

In an embodiment, the virtual compute instance generates expense reports for each preapproved expense charge or spend amount. In particular, a report link is generated and provided to access the expense reports for viewing and storing as employee expense records.

Automatic credit account reconciliation is described herein. The automatic credit account reconciliation may be accomplished while the preapproved expense charges are evaluated, for example, before the travel or event. Typically, after the trip or event, reconciliation may be required to create expense line items that correspond to payments achieved via virtual cards. The typical reconciliation may involve extensive time and indirect costs to accomplish the reconciliation, and enterprises may desire a better way to link virtual cards to the expense reports to facilitate faster reconciliation. Thus, embodiments enable the reconciliation by indicating the usage of the expense payment objects towards incoming charges and thereby generating reconciliation line items. For example, any incoming charge may be applied to the expense payment object while reducing the preapproved expense charges with the exact incoming charge. This way, the amount of time, effort, and costs may be reduced in generating reconciliation line items in the expense report that would otherwise be much more extensive and complex.

Embodiments provide a customized expense pre-approval form for updating payment type fields based on the type of credit line account and the threshold amount specified for the credit line account of the employee. The customized expense pre-approval form may be created automatically, enabling the evaluation of preapproved expense charges and the creation of virtual cards corresponding to the type of credit line account and threshold amount linked to the credit account.

In an embodiment, a computer-implemented method is disclosed for automatically creating virtual cards for various preapproved expense charges along with generating expense reports with reconciliation line items that are displayed on a graphical user interface (GUI) for reviewing and updating.

While certain embodiments have been developed based upon achieving the foregoing, embodiments also address the technical problem of how to efficiently—a) automatically evaluate preapproved expense charges from millions of expense documents including various document line descriptions and line items; b) automatically create virtual payment objects preset with validity periods, tolerance limit, threshold spend amount and currency specificity for different expenses incurred for various bookings and reservations according to specifics of the credit account; c) automatically generate expense reports with reconciliation line items for automatically facilitating credit line account reconciliation; d) automatically customizing expense pre-approval request form and corresponding fields based on type and threshold credit linked to the credit line account; and e) automatically representing a digital view of the virtual payment objects, expense reports, reconciliation line items and the preapproved expenses charged on the virtual payment card and balance information of the preapproved expenses in the virtual payment card and/or the corresponding expense reports.

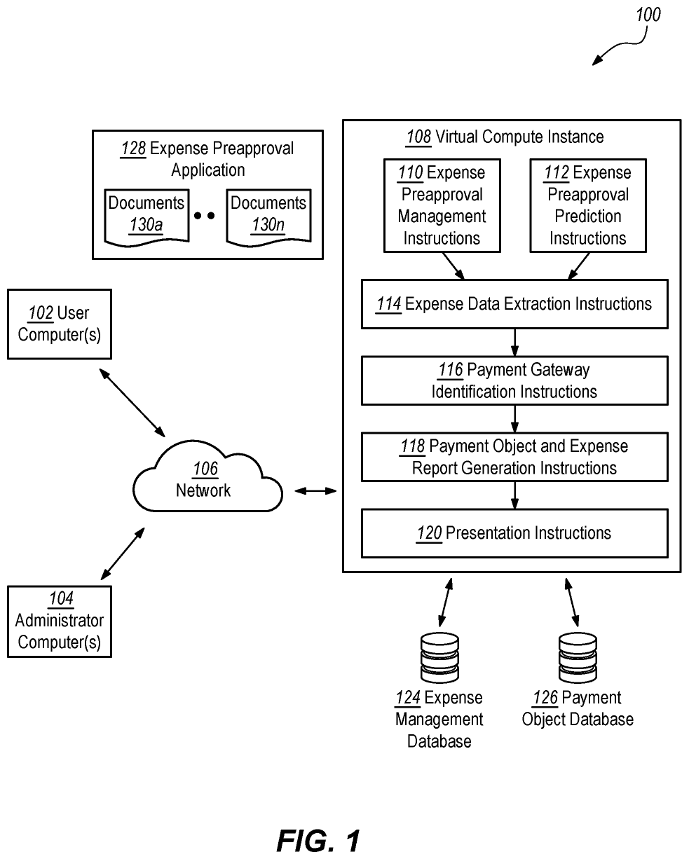

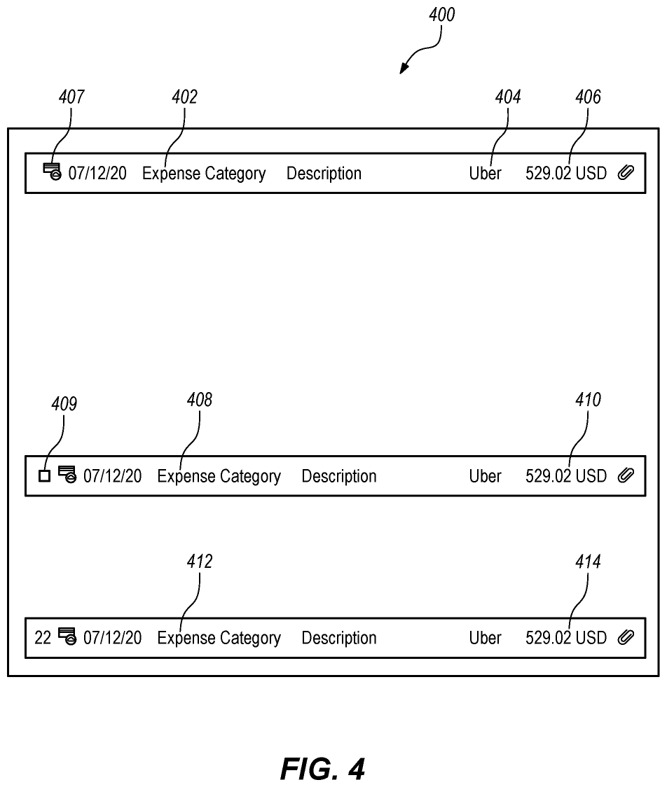

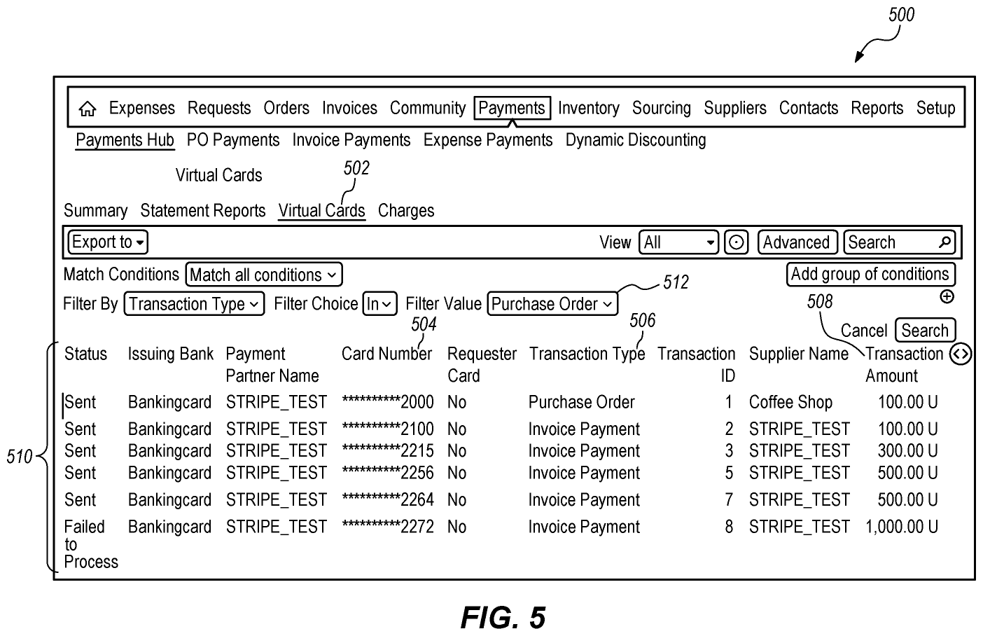

In various embodiments, aspects, and features, the disclosure encompasses the subject matter of the following numbered clauses:
1. A computer-implemented method executed using a virtual compute instance executing one or more sequences of expense management instructions, the virtual compute instance communicatively coupled to a storage device comprising a database, the method includes querying an expense pre-approval application to obtain a set of expense documents from a first computer associated with a first account that is digitally linked to a credit line account, and receiving the set of expense documents, the expense pre-approval application being one of a plurality of federated applications hosted using a multi-tenant distributed computing system that comprises the virtual compute instance; determining, for each document in the set of expense documents, expense data comprising a type of expense document, time of spend, kind of expense, and a plurality of expense charges; based on the type of document of each expense document in the set of expense documents, identifying a payment gateway among a plurality of payment gateways, each payment gateway executing a plurality of programmatic payment rails that the first account can access; using the payment gateway, evaluating preapproved expense charges based on the expense data; creating and storing in the database, a plurality of expense payment objects associated with the preapproved expense charges when a first account database table associated with the credit line account of the first account matches with a second account database table of the payment gateway, and automatically applying the plurality of expense payment objects to reduce account balances of one or more preapproved spending amounts.
2. The method of clause 1, further includes automatically generating a plurality of expense reports for each category of the preapproved expense charges; presenting a report link for each expense report.
3. The method of clause 2, further includes receiving an incoming charge having an incoming charge amount; applying, in parallel to the generation of the plurality of expense reports for each category, the incoming charge with the charge amount to the plurality of expense payment objects, and reducing the preapproved expense charges with the charge amount; creating, in the expense report, reconciliation line items indicating the charge amount for credit line account reconciliation.
4. The method of clause 1, further includes receiving, from the first computer communicatively coupled to the server computer, a request for creating expense payment objects; determining whether the credit line account of the first account is specified with a threshold percentage and a threshold amount of credit spend amount; determining a type of the credit line account corresponding to the first account; automatically customizing the expense pre-approval application with one or more payment type fields based on the type of credit line account and the threshold amount of credit spend amount.
5. The method of clause 1, further includes associating each expense payment object with a virtual card account.
6. The method of clause 1, further includes determining the expense data from each of a plurality of document line items, document line strings, document texts, and document descriptions corresponding to expense documents.
7. The method of clause 1, further includes associating each expense payment object with preapproved data that comprises a particular validity period, a particular tolerance limit, a spend amount, and currency of spend linking to the preapproved expense charges; causing to display, a digital view of the expense payment object of a virtual card account with the preapproved data; notifying the first computer with the digital view of the expense payment object for viewing and using to charge against preapproved items accredited to the credit line account as shown and described in connection with FIG. 4 and FIG. 5.
8. The method of clause 1, further includes identifying expense corporate card account data when an expense payment object is of corporate card type.
9. A virtual compute instance, for example, a server computer is described that executes one or more sequences of expense management instructions, and the virtual compute instance may be communicatively coupled databases as shown and described in connection with FIG. 1. The virtual compute instance comprises one or more processors; one or more non-transitory computer-readable data storage media coupled to the one or more processors and storing one or more sequences of instructions which, when executed using the one or more processors, cause the one or more processors to execute the methods of any of clauses 1 to 8.

One or more non-transitory computer-readable data storage media storing one or more sequences of instructions which, when executed using one or more processors, cause the one or more processors to execute the methods of any of clauses 1 to 8.

Embodiments are useful for enterprises or entities that may require pre-approvals on travel plannings, bookings, reservations, allowance, and costs for employees/travelers based on credit line accounts associated with the employees/travelers. In this context, with past systems, evaluating the expenses for different travel times, spending, and the currency of spend has been time-consuming. Employees must manually enter multiple purchase orders, invoices, and other records of different suppliers and vendors for pre-approvals. Therefore, enterprises commonly find that employees spend significant time estimating preapproved expenses and amounts while submitting a proposed travel plan or expense documents and reports for pre-approval. “Pre-approval,” in this context, refers to the approval of certain expenses before a trip or event. Employees may also submit a travel expense request without accurate cost guidance. Furthermore, managers typically have limited information at a pre-travel stage to make accurate decisions about potential budgetary impacts. Embodiments of the present disclosure provide solutions via automated methods for automatically evaluating preapproved expense charges based on credit line account links, and creating multiple virtual payment objects for enabling the employee to use the expenses as preapproved expenses for travel planning and/or travel bookings. In one embodiment, a method is programmed to create virtual payment objects and generate expense reports with reconciliation line items automatically, which reduces central processing unit (CPU) time, cycles, memory, other storage, or network bandwidth and network resources.

### 2.0 STRUCTURAL & FUNCTIONAL OVERVIEW

2.1 Example Distributed Computer System Architecture

FIG. 1 illustrates a distributed computer system with which one embodiment can be implemented. In an embodiment, a computer system of FIG. 1 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1 is shown in simplified, schematic format for purposes of illustrating a clear example, and other embodiments may include other elements. FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In an embodiment, the distributed computer network system comprises user computers 102, administrator computers 104, a virtual compute instance 108, and one or more storage devices, for example, databases including but not limited to expense management database 124, payment object database 126, and an expense pre-approval application 128, which are communicatively coupled directly or indirectly via one or more networks 106. The virtual compute instance 108, user computers 102, administrator computers 104, and other elements of the distributed computer network system may host or include interfaces that are compatible with one or more networks 106 and are programmed or configured to use standardized protocols for communication across the networks such as TCP/IP, Bluetooth, and higher-layer protocols such as HTTP, TLS, and the like.

In an embodiment, a distributed computer system 100 may be a multi-tenant distributed computing system. In an embodiment, user computers 102 and one or more administrator computers 104 are communicatively coupled, directly or indirectly, to the virtual compute instance 108 and the expense pre-approval application 128 via one or more data communication networks 106. In an embodiment, FIG. 1 shows the data communication networks 106 through which the user computers 102, the administrator computers 104, the virtual compute instance 108, and the expense pre-approval application 128 can interoperate and exchange data with one another. Networks 106 enable accessing and procuring expense documents 130a-130n of the expense pre-approval application 128. In an embodiment, the data communication networks 106 enable communicating expenses for pre-approval for creating expense payment objects. The data communication network 106 may be implemented by any medium or mechanism providing data exchange between the various user computers and systems, including the expense pre-approval application 128. Examples of the data communication network 106 include, without limitation, any cellular network communicatively coupled with a data connection to the computing devices over a cellular antenna, a near-field communication (NFC) network, a LAN, a WAN, the Internet, or a terrestrial or satellite link. The data exchanged may be formatted in a variety of different ways including for example using HTML, CSS, Javascript, XML, or JSON.

Each of the user computers 102 and the administrator computers 104 can comprise any kind of computing device, such as a desktop computer, laptop computer, tablet computer, mobile computing device, smartphone, personal computers, PDAs, laptops, or workstations. For clarity, FIG. 1 shows a user computer 102, and an administrator computer 104 as an example, but in practical embodiments, distributed computer network system can include thousands to millions of user computers and administrator computers depending upon the processing capacity of CPUs or other hardware resources of the virtual compute instance 108. For example, there may be n number of computers coupled to the virtual compute instance 108. The designation n in reference characters means that in embodiments, the actual number of elements corresponding to a reference character has no specific limit other than the processing capability of related elements.

In an embodiment, computer 102 may be associated with one or more users, customers, submitters, employees, requesters, managers, reviewers, and other computer users who are involved in requesting expense payment objects against various preapproved bookings and reservations. Each of the users requesting pre-approvals of expenses and expense payment objects has roles, privileges, and limits against which such requests are evaluated for preapproving before the actual trip or event. The requests for expense payment objects can be submitted via submission of digital electronic expense documents and expense statements, for example, purchase orders, expense bills, debit and credit card bills, invoices, quotations, and any expense-related statements in the form of digital electronic documents.

Throughout this disclosure, all references to “user” or “users” are specified for convenience but correspond to user accounts or user computers that execute the technical steps described in the disclosure. Thus, even where the terms “user” or “users” appear, all steps and functions of the disclosure are intended as computer-implemented steps or technical steps and not manual, mental, human-performed, or abstract steps, each of which is hereby expressly excluded from the scope of the claims and the disclosure.

In an embodiment, each of the user computers 102 may interoperate with the administrator computers 104 that may be associated with one or more entities having payroll services, benefits services, Accounts Payable (AP) departments for preapproving and/or funding the one or more users or employees for their travel or trip. For example, the administrator computers 104 may be computing systems associated with auditors, approvers, examiners, inspectors, and accountants who oversee approving the requests for creating and issuing expense payment objects along with expense reports during preapproving of the expenses dynamically in real-time.

In an embodiment, the user computers 102 and the administrator computers 104 may interoperate and/or may be integrated with one or more distinct and diverse applications, directly or indirectly, among a plurality of federated applications that may be integrated and programmed into a federated system. Each federated application of the plurality of federated applications may be hosted using the multi-tenant distributed computing system and may be executed by the user computers 102 and the administrator computers 104 via the data communication networks 106. For example, the plurality of federated applications of the federated system may include but are not limited to, an expense pre-approval application 128 and the virtual compute instance 108, which are described in the later section herein.

In an embodiment, each federated application may be accessed and executed via application programming interface (API) calls, HTTP GET requests, and the like. In an embodiment, the federated system may enable cross-referencing multiple pieces of travel booking and reservation plans, including user or submitter or employee information, itineraries, information of travel booking entities, suppliers, and resources, and expenses related to country-based, city-based, zone-based, and corresponding government-based policy statistics, rates, tax rates, excise rates, tolls, tariffs, prices, costs, charges, and other related expenses including per diem expenses. The procurement and analysis of these data items enable automatically evaluating allowed and preapproving expenses for items. In an embodiment, such evaluation of preapproved expense charges and creation of expense payment objects, including the generation of expense reports, may be achieved in a single application of the federated applications that can execute all the functions of both the virtual compute instance 108 and the expense pre-approval application 128.

The one or more user computers 102, the administrator computer 104, and the virtual compute instance 108 in combination with the optional expense pre-approval application 128 can be implemented using server computing technology such as a server farm, a cloud computing platform, or a parallel computer, one or more virtual compute instances and/or virtual storage instances, and/or instances of a server-based application. In an embodiment, each of the one or more user computers 102, the administrator computer 104, the virtual compute instance 108, and the expense pre-approval application 128 executes application programs. The application programs can include a browser and other elements that can implement HTTP servers to interoperate with browsers. The browser can comprise any application program that is compatible with open protocols such as HTTP and HTML; commercially available examples include CHROME, SAFARI, EDGE, INTERNET EXPLORER, or FIREFOX. In an embodiment, each of the one or more user computers 102 and one or more administrator computers 104 may be programmatically coupled to functional elements. Examples include expense data extraction instructions 114, payment gateway identification instructions 116, payment object and expense report generation instructions 118, and presentation instructions 120, which are further described in other sections herein.

The expense pre-approval application 128 is associated with customizing and providing expense pre-approval forms with various input fields and user interface (UI) widgets to obtain details of bookings, reservations, and appointments, including expense documents. The expense pre-approval forms also enable populating the input fields and UI widgets, uploading and/or fetching expense documents 130a-130n, and expense records related to expenses incurred toward various bookings and reservations. In an embodiment, documents 130a-130n may be expense documents 130 and expense records utilized for creating and linking the expense payment objects and the expense reports, including reconciliation line items related to various spends. In an embodiment, each expense document 130 and expense records may comprise various line descriptions, items, line strings, texts, and other specifics corresponding to quoting expenses and charges. Expense document 130 may also mention various booking details, for example, dates of booking, expenses for hooking, tax information, time of bookings, the currency of expenses, and so forth.

In an embodiment, the expense documents 130, and the expense records can be received and/or procured from one or more servers and one or more computing devices associated with different vendors, suppliers, merchants, and resources, for example, airline entities, train reservations, and booking entities, hotel room reservation entities, rental car reservations entities, lodging entities, and other entities related to book and/or reserve, and/or appoint, related to travel domain such as travel plans and/or travel bookings. The received expense documents 130 and the expense records may be uploaded and/or saved in one or more storage devices and data repositories associated with the expense pre-approval application 128. As an example, the storage devices and data repositories related to the expense pre-approval application 128 may store each expense document 130 and the expense record using any of a mapping table, lookup table, data structures, relational database, object database, flat file system, SQL database, or no-SQL database. In an embodiment, the storage devices and the data repositories may be configured to be entities-specific, suppliers-specific, and resources-specific databases containing entries of the bookings according to entries of information of the users, customers, candidates, applicants, submitters, employees, requesters, petitioners, personals, teams, and other individuals, in an embodiment, the expense pre-approval application 128 may be configured based on a plurality of payment gateways associated with different payment rails. For example, the expense pre-approval application 128 may customize and populate the expense pre-approval forms with various input fields and UI widgets based on a type of credit line account and/or payment gateway associated with a particular payment rail to avail different expense payment objects and corresponding expense reports against requests for preapproved expense charges.

In one embodiment, various systems of the multi-tenant distributed computing system and/or federated applications are integrated over the data communication network(s) 106 that may be accomplished using one or more data integration protocols. One possible integration protocol may use flat files (for example, CSV flat files) uploaded to and downloaded from a secure file transfer protocol (SFTP) server operated by any of the user computers 102 that are able to access and implement the virtual compute instance 108. The flat files may be CSV files, for example, that contain expense documents 130, expense records, and bill data incurred for various bookings and reservations. In another embodiment, another possible integration protocol for importing expense documents 130, expense records, and other expense-related data is by using a REST API offered by various servers associated with the virtual compute instance 108. For example, the flat file integration protocol may be used for bulk import of supplier-customer information, and the REST API integration protocol may be used for real-time import of expense information. The purpose of the integration may be to exchange data or to import expense documents 130, expense records, and other related details to or from the virtual compute instance 108. The expense documents 130, the expense records, and the related details may be processed and analyzed by various instructions stored in the virtual compute instance 108, including instructions that implement techniques disclosed herein. From the analysis of different populated expense documents 130, expenses for pre-approval are evaluated, and multiple expense payment objects are created. Each stage of such evaluation and creation of expense payment objects are presented on a GUI for viewing from the user(s) or request submitters and/or the request approvers.

In an embodiment, the virtual compute instance 108 is implemented using one or more computing devices that are programmed for the creation of expense pre-approval forms, expense payment objects, and expense reports. In some embodiments, the virtual compute instance 108 may be implemented as a server computer, including but not limited to a server-class computer or other computers having one or more processor cores, co-processors, or other computers. Virtual compute instance 108 may be a physical server computer and/or a virtual server instance stored in a data center, such as through cloud computing. In various embodiments, the virtual compute instance 108 can comprise any of a single-machine processor, multi-processor machine, a processor or machine cluster, and/or virtual storage instances to process the expense documents 130, expense records, expense pre-approval forms and automatically create expense payment objects.

According to one embodiment, the virtual compute instance 108 is communicatively coupled to expense pre-approval application 128, which can be hosted using one or more server computers, other computing devices, and/or one or more virtual compute instances and storage instances that are coupled using the network 106, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

The virtual compute instance 108 comprises or executes a web server including or comprising an HTTP server that can process user requests, transmit responses including HTML payloads with dynamically generated web pages, and can include a firewall, load balancer, or other infrastructure to manage a large number of requests from the user computers 102 associated with the creation of expense payment objects and expense reports corresponding to the request of preapproved expense charges.

The virtual compute instance 108 can execute in a multi-tenant, multi-instance architecture in which large numbers of requests of user computers 102 are processed, using separate or shared data storage with security controls. Further, the virtual compute instance 108 can comprise a set of executable program instructions or units of instructions such as executables, binaries, packages, functions, methods, or objects that are hosted on one or more virtual computing instances of public data centers, private datacenters, or cloud computing facilities. The virtual compute instance 108 can be programmed to execute per-tenant basis procurement and evaluation functions, where per-tenant corresponds to multi-tenant environments, including various companies, industries enterprises, and entities that may be large-scale enterprises or small-scale enterprises. Further, per-tenant corresponding to the multi-tenant environments may be associated with the users, customers, candidates, applicants, submitters, employees, requesters, petitioners, personals, teams, and other kinds of individuals who are requesting pre-approval on expenses and issuance of expense payment objects. The virtual compute instance 108 can execute per-tenant-specific expense requests information including, but not limited to, a plurality expense documents 130, expense records, multiple trip expense data, the user/employee information with roles and eligibilities data who is requesting the creation and issuance of the expense payment objects, the employer's policy data, and the travel booking entity, supplier, and resources information, and other information for evaluating preapproved expenses based on the credit line account of the employee.

FIG. 1 illustrates example components of the virtual compute instance 108 in one embodiment. In various embodiments, one or more of the functional components can be implemented as software components, general or specific-purpose hardware components, firmware components, or any combination thereof. The virtual compute instance 108 can be programmed as multiuser software-as-a-service (SaaS) applications that interoperate with user computers 102, the administrator computers 104, and the expense pre-approval application 128, including other applications that are part of the federated system, via browsers. A commercial example of the virtual compute instance 108 is the Coupa Pre-approval Management platform of Coupa Software Incorporated, San Mateo, California. However, all references in this document to “Coupa” or “coupa” represent examples for one embodiment, and other embodiments can use other labels and/or need not implement every feature or function of Coupa.

In an embodiment, the virtual compute instance 108 is communicatively coupled with the expense management database 124 and payment object database 126, which can be a relational database programmed to store various expense data, for example, type of expense document, time of spend, kind of expense, and a plurality of expense charges, multiple trip itineraries, the user/employee information with roles and eligibilities data who is requesting the expense payment objects, the policy data applicable for allowance of preapproved expense charges, and the travel booking entity, supplier and resources information, and other information for creating expense payment objects and expense reports. The expense management database 124 may store various enterprise-specific and government-specific preapproved rules and policies that are applied to preapprove expenses for the credit line account of the employee.

In an embodiment, the expense management database 124 is further configured to store configuration data to specify information about an expense payment object issuer and related operational details to control the creation of the expense payment objects with a specific validity period, tolerance limit, a spend amount, and currency of spend linking to the preapproved expenses. The configuration data may also specify the mapping of incoming charges to a holding account and categorize charges by a merchant category code to automate charge handling. The configuration data also can define approval chains, consisting of an association of conditions, values, operators, and destinations defined in terms of account identifiers, to route the submission to other users for review and approval. An approval chain can specify one or more account identifiers of users of user computers 102 or administrator computers 104 that receive programmatic requests to review and approve pre-approvals forms.

The payment object database 126 may store information and details of various expense payment objects, for example, information on different virtual cards automatically created towards payment of preapproved expense charges. While the expense management database 124 and the payment object database 126 are specified as the relational database as an example, other embodiments can use any combination of large-scale digital data storage devices or systems, including object stores, flat file systems, or no-SQL databases, including any combination of those from SPARK, AMAZON AWS, AMAZON S3, GOOGLE CLOUD, MICROSOFT AZURE, EMC, APACHE HADOOP, or others.

The virtual compute instance 108 comprises computer-executable stored program instructions including, but not limited to, expense pre-approval management instructions 110, expense pre-approval prediction instructions 112, expense data extraction instructions 114, payment gateway identification instructions 116, payment object and expense report generation instructions 118, and presentation instructions 120.

Each of the computer-executable stored program instructions can be programmed to call functions, methods, or application programming interfaces (APIs) to retrieve information from various multiple expense-related data from user computer 102, administrator computers 104, and/or the expense pre-approval application 128.

The expense pre-approval management instructions 110 are programmed or configured to access different account details and information of an employee with respect to whom the expense payment objects are created. In an embodiment, the expense pre-approval management instructions 110 are configured to determine and identify a payment gateway among a plurality of payment gateways. The identification of the payment gateway is associated with a payment rail that is accessible by the employee's account, including the credit line account. In an embodiment, the expense pre-approval management instructions 110 are configured to manage the application of incoming charges to the expense payment objects and create expense reports with reconciliation line items for credit line account reconciliation. The expense pre-approval management instructions 110 are configured to customize the expense pre-approval forms based on the nature of travel, agenda of booking, nature of task/work, type of credit line account, and a threshold amount of credit spend amount for the employee. In an embodiment, the expense pre-approval management instructions 110 are configured to create virtual cards and/or corporate cards when expenses are preapproved based on a corporate-based credit account.

The expense pre-approval prediction instructions 112 are programmed or configured to interoperate with the expense pre-approval management instructions 110 for the creation of expense pre-approval forms and expense payment objects. The expense pre-approval forms may be stored in a relational database, for example, the expense management database 124, and the expense payment objects may be stored in the payment object database 126. In an embodiment, the pre-approval prediction instructions 112 can formulate a query that comprises a selection of expense payment objects and submit the query via the expense pre-approval application 128. In an embodiment, pre-approval prediction instructions 112 are programmed to call functions, methods, or APIs to retrieve price records of different bookings and reservations from the servers and one or more computing devices associated with different vendors, suppliers, merchants, and resources. In an embodiment, the pre-approval prediction instructions 112 are programmed to execute the functions (that are described further in other sections of this specification) individually or with interoperation with the virtual compute instance 108 and the expense pre-approval application 128. The functions may include processing preapproved expense payment objects, for example, preapproved virtual cards. In an embodiment, preapproved virtual cards can make paying for business expenses easy. In an embodiment, expense pre-approval prediction instructions 112 are configured to generate predictions on expense reports along with predictions of reconciliation line items for credit line account reconciliation. This enables the user/employee to receive pre-approval along with access to the virtual card to pay for high-cost items such as flight reservations and accommodations.

The expense data extraction instructions 114 are programmed or configured to intemperate with the expense pre-approval management instructions 110 and the expense pre-approval prediction instructions 112. The expense data extraction instructions 114 are configured to query the expense pre-approval application 128 to obtain a set of expense documents 130 from a user computer 102. The user computer 102 is associated with a user account that is digitally linked to a credit line account. In an embodiment, the expense data extraction instructions 114 receive a request for creating expense payment objects from the employee/user. Based on the received request, expense pre-approval application 128 may be customized with expense pre-approval forms with one or more payment type fields and data entry fields. The expense pre-approval forms with the payment type fields and data entry fields are generated based on the type of credit line account and the corresponding threshold amount of credit spend amount. The payment type fields and data entry fields are filled out by the user or administrator via linking the plurality of expense documents 130 and/or expense records. For example, using the expense pre-approval forms, the user can request the virtual card and submit details with any supporting documents about what and why they are proposing to spend. From the various payment fields and data entry fields of the expense pre-approval forms, the expense data extraction instructions 114 may be configured to extract the set of expense documents 130 along with information on threshold percentage, threshold amount associated with credit spend amount, and a type of credit line account for pre-approval. In an embodiment, the extracted expense documents 130, threshold percentage, threshold amount associated with credit spend amount, and the type of credit line account may be user-specific or employee-specific that can be analyzed based on an employee's role in the enterprise or company. For example, the employee's role is manager, partner, CEO, or director, and expense eligibilities are determined based on the user or employee's role for traveling, various bookings, reservations, and appointments at various different locations, multiple trip itineraries containing details of trip event data, for example, an arrival date value, an arrival time value, a departure date value, and a departure time value. The expense data extraction instructions 114 may be further configured to extract the nature of travel, agenda of booking, and nature of task/work, for example, whether pre-approval on the expenses is requested for travel for network development, or setting up work or business meetings. In an embodiment, each of the expense-related data for data extraction can be queried via the expense pre-approval forms as of the time of this writing, for example, AMADEUS, SABRE, TRAVELPORT, FLIGHTLOGIC, EXPEDIA, RATEGAIN, MAKCORPS, HOTELBEDS, WEBBEDS, BONOTEL, RENTALCARS, CARTRAWLER, and others.

The payment gateway identification instructions 116 are programmed or configured to determine expense data including, but not limited to, type of expense document, time of spend, kind of expense, and the plurality of expense charges from the set of expense documents 130 and the expense records acquired from the expense pre-approval application 128. The payment gateway identification instructions 116 are configured to identify a particular payment gateway among the plurality payment gateways that enables the user account to access a payment rail of the particular gateway for creating the expense payment objects. In an embodiment, the particular payment gateway may be assigned to one or multiple payment rails and the user account can access the multiple payment rails. Based on the type of expense document 130 submitted via the expense pre-approval application 128, the particular payment gateway is enabled. For example, if the user is requesting pre-approval expenses for a purchase order, payment rails linked with purchase orders are accessible when the credit line account of the user is linked with the payment gateway of purchase order type. The payment gateway identification instructions 116 are configured to evaluate or predict preapproved expense charges based on the type of expense document 130 and the particular payment gateway. The payment gateway identification instructions 116 are further configured to evaluate or predict incoming charge amount and apply to the preapproved expense charge availed through the expense payment objects.

The payment object and expense report generation instructions 118 are programmed or configured to create a plurality of expense payment objects associated with the preapproved expenses charges when a user account database table associated with the credit line account of the user account matches with a payment account database table of the payment gateway. The payment object and expense report generation instructions 118 are configured to store the plurality of expense payment objects in the payment object database 126 including details of the payment objects. The details of the payment objects include but are not limited to, the type of payment object, type of expense document the expense payment object corresponds to, validity period, tolerance limit, expiration date, billing information, employee details associated with the expense payment object, an image of the expense payment object, total spend amount preapproved, balance preapproved amount, reference number of the expense payment object, identification number, and the like. The payment object and expense report generation instructions 118 are further configured to automatically apply the plurality of expense payment objects to reduce account balances of one or more preapproved spending amounts. In an embodiment, the payment object and expense report generation instructions 118 are programmed to automatically generate a plurality of expense reports for each category of the preapproved expense charges and present a report link for each expense report on the GUI of the user computer 102 and/or administrator computer 104 for reviewing and examining. In an embodiment, the payment object and expense report generation instructions 118 are programmed to create reconciliation line items in the expense report for indicating the charge amount for credit line account reconciliation. In an embodiment, the payment object and expense report generation instructions 118 also generate links between expense corporate card account data and the credit line account of the user account when an expense payment object is of corporate card type.

The presentation instructions 120 are programmed or configured to represent a digital view of the expense payment object of a virtual card account with preapproved expense data for display. In this context, the user computer 102 may be notified with the digital view of the plurality of expense payment objects and use them to charge against preapproved items accredited to the credit line account during the spend. The presentation instructions 120 are programmed or configured to provide a visual representation of each evaluation of the preapproved expense charges, the digital view of the plurality of expense payment objects, and expense reports. The presentation instructions 120 cause displaying interface elements for receiving input or updates specifying a request to add details to the expense payment objects and expense reports. Presentation instruction 120 further causes displaying a graphical bar with a prompt for each stage of evaluation of the preapproved expenses and updated expense reports. In one embodiment, presentation instruction 120 further causes displaying a graphical bar with a prompt for reviewing and updating an expense pre-approval form via the GUI accessing the expense pre-approval application 128.

Presentation instruction 120 further causes displaying a notification about the approval or decline of pre-approval expense request based on at least one of 1) upon determining any information missing in the expense pre-approval form, and 2) the review of the expense document 130 and threshold amount of credit spend amount associated with the credit line account of the user account. The approval or decline of the pre-approval expense request is accomplished via one or more interface elements to enable the user computer 102 or administrator computer 104 to change one or more data entries in the expense pre-approval forms. The interface elements include but are not limited to, icons, drop-down menus, radio button options, checkboxes, drop-down menus, drag-and-drop selections, and text fields. In an embodiment, a prompt relating to approval or decline with respect to pre-approval expense request and expense payment objects are visually indicated using one or more indicators including, but not limited to, visual indicators, visual noise, flag indicators, highlight indicators, labeling indicators, tagging indicators, pointer indicators, classifier indicators and other kinds of prompt indicators. The prompt can trigger the attention of the reviewer, which can include an employee or request submitter, administrators, and approvers like the AP team or auditors updating the credit spend amount.

2.2 Example Programmed Process of Automatically Creating Expense Payment Objects and Expense Reports

2.2.1 Process Overview

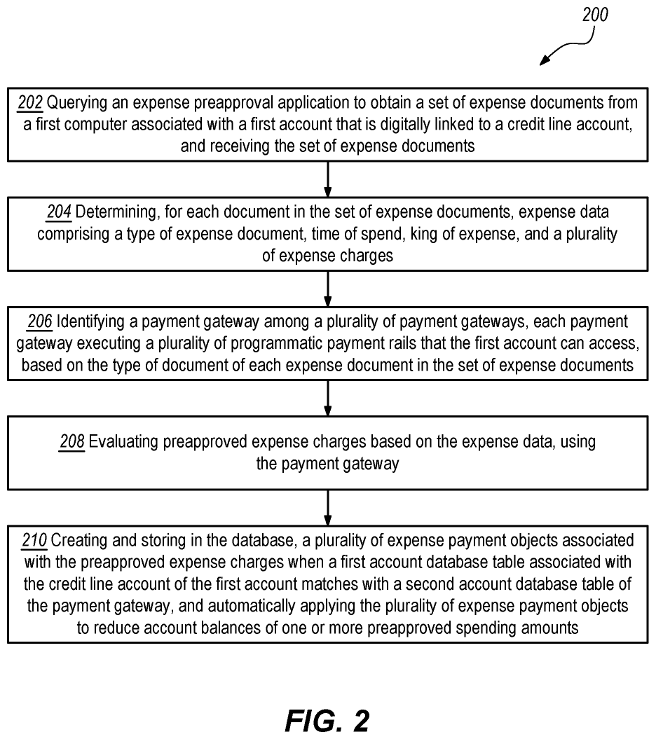

FIG. 2 is a flow diagram depicting an example method for creating virtual payment objects for preapproved expense charges, according to an embodiment. FIG. 2 depicts an example flowchart for a process that can be programmed for one embodiment. The example of FIG. 2 is programmed for creating the plurality of expense payment objects and the plurality of expense reports for preapproved expense charges along with representing on the GUI that may be facilitated by the virtual compute instance 108, according to an embodiment.

Process 200 uses the virtual compute instance 108, which is one of the federated applications hosted using the multi-tenant distributed computing system or federated system.

Process 200 begins at step 202, which is programmed for querying an expense pre-approval application 128 to obtain the set of expense documents 130 from a first computer associated with a first account. The first computer may be any of user computers 102, and the first account may be any of the user accounts that are digitally linked to a credit line account. In an embodiment, the process 200 queries the expense pre-approval application 128 upon receiving an expense pre-approval request from the user/employee for creating the plurality of expense payment objects towards one or more bookings or reservations. In an embodiment, in response to receiving the expense pre-approval request, the process determines whether the credit line account of the first account is specified with a threshold percentage and a threshold amount of credit spend amount. For example, the threshold percentage specifies a percentage of credit spend amount preapproved for spend and the threshold amount specifies the total amount preapproved for the credit line account. Based on the threshold percentage, the threshold amount of the credit spend amount, and the user role in the business entity, the type of credit line account corresponding to the first account is determined. For example, the type of credit line account may include, but is not limited to, personal account, company account or corporate account, and the like. Based on the type of credit line account and a threshold amount of credit spend amount, virtual compute instance 108 generates instructions to the expense pre-approval application to generate one or more user interface (UI) widgets, input fields, data entry fields, or text fields, for expense pre-approval forms. In an embodiment, process 200 includes a step for customizing a default expense pre-approval form according to the type of credit line account and the threshold amount of credit spend amount.

2.2.1.1 Virtual Card Setup

At step 202, virtual compute instance 128 interoperates with the expense pre-approval application 128 to customize or generate the expense pre-approval forms by adding a new “Virtual Card” widget for both expense pre-approval and trip expense approval. The new widget “Virtual Card” may be shown in the questionnaire section under fields for expense pre-approval. Upon adding the “Virtual Card” widget on the expense pre-approval form, a plurality of radio buttons may be represented to provide options for either choosing the creation of virtual cards as expense payment objects for pre-approval expenses or the creation of different payment methods for pre-approval expenses. In some embodiments, virtual cards may be created as a default setting. In an embodiment, the expense pre-approval forms may be configured with one or more input fields to add validation that prevents administrator computers 104 from adding more than one payment type to the same expense pre-approval form. For example, assuming a widget corresponding to one payment type, for example, cash advance or virtual card, is added to the expense pre-approval form. When the administrator computer 104 tries to add more payment method types, then an error message is indicated stating, “Expense Pre-approval Forms can only support one payment type”. In an embodiment, the option of the virtual card can be hidden, and in such situations, the payment method type will not contain the option of leveraging the virtual card.

2.2.1.2 Mapping of Virtual Card Setup to Corporate Card Settings

In an embodiment, the virtual compute instance 108 interoperates with the expense pre-approval application 128 to customize or generate the expense pre-approval forms by incorporating virtual card settings in the corporate card settings page. For example, different widgets are created for both corporate cards and virtual cards for user selection towards creating pre-approval expense payment objects based on any of the corporate cards and virtual cards. In an embodiment, expense pre-approval forms may be configured with general expense card settings that apply to both virtual cards and corporate cards. In an embodiment, at step 202, general expense card settings may be queried from the expense pre-approval application 128. Each of the virtual cards and corporate cards is mapped to industry code type, industry code, actions, and expense categories related to categories of items preapproved for buying or booking via preapproved payment methods. In an embodiment, the virtual card may be associated with a particular payment gateway or payment partner, while the corporate card may be associated with corporate card integration.

In some embodiments, settings of corporate cards may be associated with category mapping for defining how each corporate card integration and associated industry code type may be mapped to expense categories. In an embodiment, settings of corporate cards help streamline integration and reconciliation. Corporate cards are associated with field settings, bill cycle end dates, notification reminders, user mapping, default categories, transaction filters, and MasterCard unique ID settings. The field settings enable the employees to change expense line fields. Bill cycle end dates for setting the card feed cutoff data for each expense line transaction in a billing cycle each month. Notification reminders specify the number of days beyond each monthly corporate card bill cycle date to send a corporate card reminder email. The user mapping maps each corporate card integration to an associate employee. The default category may be assigned to each transaction where no set industry code mapping is found. The transaction filters filter out certain corporate card integration types that may be ignored when importing feeds. MasterCard unique ID settings specify the reference of source value filed from the MasterCard CDF3 file when reconciling MasterCard transactions. In an embodiment, one or more expenses related to corporate cards may be grouped by bill date. In an embodiment, separate expense reports may be generated for each trip or booking.

In some embodiments, the user/employee may be enabled to access the expense pre-approval form setup page with an entitlement of both corporate cards and virtual cards. If the user/employee's account is linked with a credit line account that may be associated with both corporate cards and virtual cards, all settings of the expense pre-approval form are represented actively. The virtual card widgets are hidden for default user mapping when the user/employee is associated with only corporate cards. Similarly, the corporate card widgets are hidden for default user mapping when the user/employee is associated with only virtual cards. All the settings for creating payment objects are disabled or restricted when the user/employee is not associated with any of the virtual cards and the corporate cards.

2.2.1.3 Expense Data

At step 204, for each document in the set of expense documents 130 acquired at step 202, expense data is determined. In an embodiment, the expense data may include but is not limited to, the type of expense document, time of spend, kind of expense, and a plurality of expense charges. In an embodiment, the expense data may be determined from each of a plurality of document line items, document line strings, document texts, and document descriptions corresponding to expense documents 130. Type of expense document may include, for example, purchase order document and invoice type document. Time of spend defines different times when payments are made or required. For example, the time of spend may be based on itineraries and lodge timings. The kind of expense may define whether the expense is toward rental bookings or meals or entertainment, or hotel reservations. The plurality of expense charges may be different charges or amounts related to different spends, for example, office supplies, internet, phone, dues/membership/subscriptions, employee training, entertainment, meals, gifts, rental car, airfare, and lodging and the like.

2.2.1.4 Payment Gateway

At step 206, a payment gateway among the plurality of payment gateways is identified based on the type of document of each expense document in the set of expense documents 130. In an embodiment, the payment gateway may be created with a configuration suitable for accessing issuing banks and networks. The creation of each payment gateway configures a plurality of programmatic payment rails that the first account, for example, the user account can access. In an embodiment, based on the type of expense document, the payment gateway configuration controls the availability of the payment rails for the credit line account. For example, for each payment rail, including bank transfers, digital checks, digital wallets, and virtual cards, a corresponding payment gateway setup may be created or enabled. In some embodiments, the payment rail is enabled for a specific type of expense document if the preapproved expense charges are enabled for such a specific type of expense document. In an embodiment, the payment gateway is identified when the type of expense document 130 is any invoice, purchase order, or expense record. The payment gateway of invoice type may be identified and enabled to process pre-approval on invoice-type expense documents. The payment gateway of the purchase order type may be identified and enabled to process pre-approval on purchase order type expense documents. For example, for generating a virtual card for a purchase order, the payment partner associated with the purchase chart of accounts is identified when the payment gateway is associated with the purchase order type. In some embodiments, the payment gateway of both types including invoice type and purchase order type may be enabled to process any type of expense documents. For example, a default setting of expense payments may be processed for all types of expense documents.

At step 206, while creating a common payment application (CPA), a particular payment gateway among a list of available payment gateways is identified by filtering the available payment gateways to match with the current identified type of expense documents, for example, when document instances >=R30. Depending upon the type of expense document, the existing expiry days attributes may be configured for the payment gateway. For example, the existing expiry or valid days attributes may be split into two specific fields. One field may be related to the purchase order document type and the other field may be related invoice document type. In an embodiment, depending upon which document type the payment gateway is associated with, only one of the two specific fields of expiry or valid days attributes or in some scenarios both the specific fields specifying expiry or valid days attributes may be created.

In an embodiment, the user/employee or administrator may disable the entire payment gateway generation, for example, a customer can use virtual cards on the purchase order and can add “expense pre-approvals” to the same payment gateway. However, the customer cannot disable the use of the virtual card on the purchase order as this may impact inflight transactions. In this context, the payment gateway may be disabled. In some embodiments, the user may apply the same credit line account for all types of expense documents 130. In an embodiment, the association of the type of expense document 130 with the payment gateway can be configured individually and separately.

In an embodiment, the payment gateway may be configured with a particular type of account containing a database table for storing identifiers for each stage of expense payments. For example, the payment gateway may contain a charge-holding account for handling all the charges of preapproved expense payments. In some embodiments, the plurality of payment gateways may be created with one or more pre-approval fields. The pre-approval fields may include, for example, expense pre-approval days valid, expense pre-approval tolerance percent, and charge holding account enabling the user to select a particular type of account for charge holding.

At step 208, preapproved expense charges are evaluated based on the expense data. In an embodiment, the preapproved expenses charges are evaluated based on one or more factors, including but not limited to, the payment gateway, payment rails accessible by the user account, credit line account, threshold amount, threshold percentage of credit spend amount, user role and agenda of seeking the pre-approval on expenses.

2.2.1.5 Expense Payment Objects

At step 210, the virtual compute instance 108 determines whether the user account database table associated with the credit line account of the user account matches with a payment account database table of the payment gateway. For example, the virtual compute instance 108 determines whether the chart of account (COA) of the user account matches with charts of account (COA) of the payment gateway to generate payment objects when the user/employee selects for payment objects pre-approval on the expense pre-approval form. The COA details of the user account may be determined from the billing string specified in the expense pre-approval form. In an embodiment, in the CPA user interface, the payment gateways may be selected for creating the expense payment objects and thus the COA of the particular payment gateway is matched with the COA of the user account. Upon determining that the user account database table matches the payment account database table, a plurality of expense payment objects is created and stored in the payment objects database 126. Each of the plurality of expense payment objects is associated with the preapproved expense charges, for example, the charges that are categorized for pre-approval. For example, in enterprises, for purchase orders, virtual cards may be generated only if the payment gateway associated with the purchase order's COA is associated with the purchase order. In an embodiment, each expense payment object may be specified with expense fields for linking with preapproved expense charges. The expense fields include but are not limited to, a particular validity period, a particular tolerance limit, spend amount, and currency of spend. In an embodiment, the expense payment objects are processed through multiple approval chain conditions for the pre-approval approval chain.

In an embodiment, a digital view of each expense payment object is represented on the GUI for viewing. The expense payment objects are represented on the GUI after the two-factor authentication process. For example, when end-users want to view their issued pre-approval virtual card on the user interface, the user may be prompted to enter two-factor authentication. The two-factor authentication may be required to be enabled on the user computers 102 for viewing the expense payment objects. The digital view of the expense payment includes payment object details, for example, a link to open the virtual card, expense pre-approval details, virtual card details, billing address information, card image, and notification when the virtual card is ready to use. The expense pre-approval details include reference pre-approval number, dates valid, and pre-approval total. The virtual card details include the card number, expiry date, CVV number, issue date, validity period, and a link to access the card. In an embodiment, the virtual card details also include four hashed digital virtual card number that is linked to the payment application user interface.

2.2.1.6 COA Validation for Creating Expense Payment Objects

The process may perform COA validation for creating expense payment objects. For example, if the user or employee submits multiple accounts attributes on the expense pre-approval form, then the virtual compute instance 108 performs COA validation that restricts the user/employee from selecting pre-approval requests if the COA of different user account attributes does not match with the COA of the payment gateway. In an embodiment, an error message is displayed when the user/employee tries to submit a standard or trip pre-approval request with different COAs. The error message may display “Billing accounts must all belong to same chart of accounts”.

In another example, if the user/employee submits COA on a credit line account that may not supported by the payment gateway, the expense payment objects will not be generated. An error message may be displayed stating that the virtual card is not generated with the selected chart of accounts.

If the user/employee submits a blank expense pre-approval form without specifying COA, a default COA from the user account is selected. If the default COA is not available, virtual card is not generated.

In an embodiment, at step 210, the plurality of expense payment objects is automatically applied towards spend to reduce account balances of one or more preapproved spending amounts. The user/employee or the administrator may be notified of the usage and application of the plurality of expense payment objects towards any preapproved spend and preapproved items. In an embodiment, the virtual compute instance 108 may execute a “pay expense pre-approval model” for a “payable” representation of the preapproved expense charges. Table 1 shows various preapproved expense charges related entries for applying the expense payment objects towards the preapproved expense charges:

TABLE 1

| | |
|---|---|
| expense_pre-approval_id, | Identifies the expense pre-approval instance |
| | that triggered the creation of a virtual |
| | card instance. |
| user_id | Identifier of the user/employee issued with |
| | the virtual card |
| type | Refers to different subtypes based on the |
| | use case or a single subtype, |
| | Payables::VirtualCardExpensePre-approval. |
| | For cash advance-based pre-approvals, an |
| | embodiment support |
| | Payables::CashAdvanceExpensePre-approval |
| remittance_amount | The approved amount that can be paid for |
| | this pay_expense_pre-approval instance. |
| paid_amount | The sum of received charges received against |
| | the virtual cards associated with this object |
| remaining amount | The remaining amount that can be paid, that |
| | will equal (remittance_amount − |
| | paid_amount) |
| currency_id | The currency for the amounts |
| accounting_amount | The pre-approval total amount in the |
| | accounting currency, excluding a tolerance |
| accounting_currency_id | Identifier of the accounting currency |
| account_type_id | Type of the account identifier |
| reporting total | The pre-approval total amount in the |
| | reporting currency, excluding a tolerance |
| status | status of creation or the usage of the |
| | virtual card |
| payment channel | COUPA Payment application used via the |
| | payment gateway |
| created at, updated at | The location where the virtual card is |
| | associated to. |

For each expense payment object being issued and used towards any preapproved expenses charges or spends, a plurality of expense reports may be automatically generated. In an embodiment, a plurality of expense reports may be generated for each category of the preapproved expense charges. Each expense report is represented with a report link on the user interface of the administrator computer 104, and/or the user computers 102. In some embodiments, the plurality of expense reports for preapproved expense charges may be created upon receiving a request from the user/employee or the administrator. The plurality of expense reports may be generated in descending order and sorted by date of creation. In exemplary embodiments, the standard pre-approval expense report is generated towards preapproved trip expenses if the trip-based expenses are enabled. The standard expense report is generated if the virtual card creation is associated with the standard pre-approval. The standard expense report is generated if the virtual card creation is associated with the trip pre-approval even when trip-based expenses are disabled. The trip-based expense report is generated if the virtual card creation is associated with the trip pre-approval when trip-based expenses are enabled.

In an embodiment, the process is programmed to receive an incoming charge having an incoming charge amount. The incoming charges against a virtual card, linked to the expense payment objects, may trigger the creation of a “coupa_pay::charge_payment” to correctly apply the incoming charge amount against the expense payment object. Thus, in parallel to the generation of the plurality of expense reports for each category, the incoming charge may be applied with the charge amount to the plurality of expense payment objects, reducing the preapproved expense charges with the charge amount. Based on the incoming charge amount, reconciliation line items are created indicating the incoming charge amount for credit line account reconciliation. For example, in parallel, the incoming charge may be forwarded to the virtual card to create reconciliation line items. The logic performed for reconciliation is similar to processing charge reconciliation towards handling purchase order payment invoices. For example, reconciliation line items for charge payment may be created against the associated preapproved expense charges. The reconciliation line items reflect the exact amount of the incoming charge amount along with specifying the preapproved expense charge and adjustment amount to match the incoming charge amount. For example, with a virtual card of $120 (tolerance included) and an incoming charge of $50, the retained transaction amount will be $120, and an adjustment amount of $70 will be automatically applied, to make the payment amount of exactly $50. This payment will be directly marked as completed successfully, triggering the creation of a reconciliation line against the preapproved expense charges exactly the charge amount. In an embodiment, the status of the preapproved expense charges may be updated based on the paid amount compared to the remittance amount.

In an embodiment, the process is programmed to create new types of pay expenses. For example, once the expense report including a pre-approval with the virtual card is approved, a second pay expense may be created after the expense report is approved for payment. In an embodiment, the existing expense report generated for the virtual card, which was consumed before holds the remaining amount to pay, the second pay expense will hold the already reimbursed amount of the expense report. For example, a fully consumed preapproved expense charge of $300, using a virtual card, is being used in an expense report with a total of $500. Once the expense report is approved for payment, two pay expenses objects will be created. One pay expense is created with the type “expense_reimbursement”, with a remittance amount of $200 and another pay expense is created with the type “preapproved expense”, with a remittance amount of $300. In an embodiment, full payment made towards both the pay expense of type “preapproved_expense” and the “expense_reimbursement” will mark the associated expense report as fully paid. Similarly, for the corporate card type, the amount covered by the corporate card may be addressed by a separate type of pay expense “corporate_card”. The pay expense for the corporate card type will be marked as fully paid. In this way, the existing functional gap is reduced where the expense reports only paid by the corporate card were generating pay expense with a total of “0” which involved integration issues. In an embodiment, the pay expense type “expense_reimbursement” is allocated automatically to make a full payment towards the preapproved expense charges. For example, assume that $300 from the expense pre-approval has been used in two different expense lines of $100 and $200. Once the expense report is approved for payment, two allocation lines will be created from the associated payment expense pre-approval against the pay expense type “preapproved_expense”, respectively of $100 and $200. These allocation lines will then trigger the creation of two instances of reconciliation line items for making creating expense report showing the payments as fully paid.

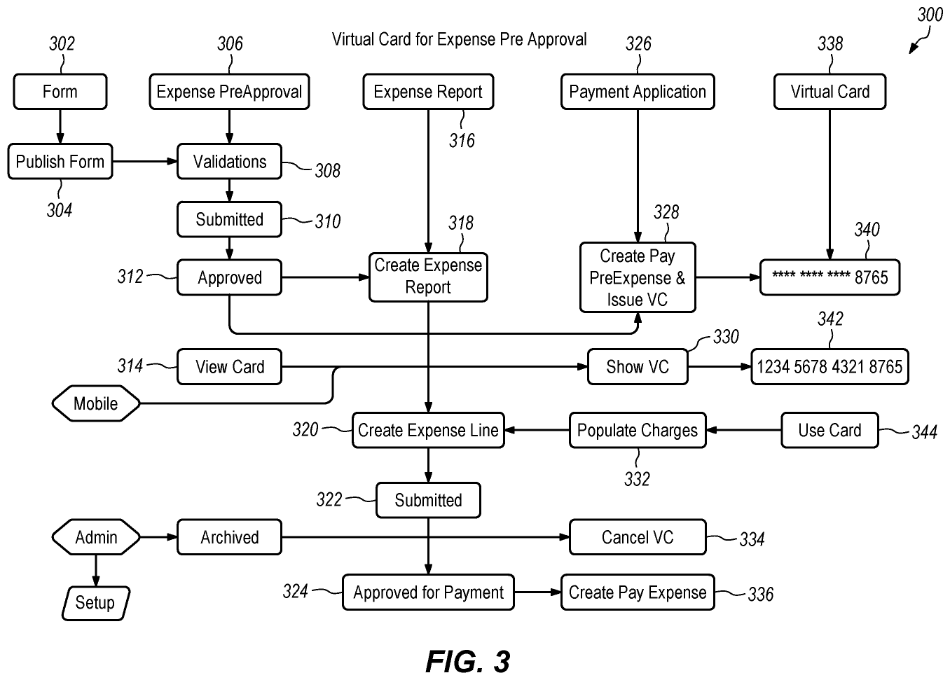

FIG. 3 illustrates a process flow or algorithm that can be programmed to generate virtual payment objects and expense reports with reconciliation line items for credit line account reconciliation, according to an embodiment. A process 300 begins at step 302, providing access to the expense pre-approval form to the user for populating various data entry fields and expense documents. For requesting the creation of a new virtual card, a new virtual card widget is selected on the expense pre-approval form. For example, the new radio group widget “Payment Type” needs to be added to standard pre-approval and trip pre-approval forms. In an embodiment, a cash advance widget can be added to the expense pre-approval form for rendering virtual card details when pre-approval is approved.

At step 304, the expense pre-approval form may be published upon receiving the populated form. The expense pre-approval form including the plurality of expense documents may be acquired by the virtual compute instance 108.

At step 308, an expense pre-approval form 306 is received and subjected to one or more validations. In some embodiments, COA may be explicitly determined or derived from the user account details or user profile. In an embodiment, different segments of trip pre-approval expenses may have accounts from the same COA. The validation includes determining a link between the COA and the payment gateway.

At step 310, the expense pre-approval form is submitted after validation. At step 312, the expense pre-approval form is approved. Asynchronously with respect to approval of the expense pre-approval form at step 312, the process may receive a digitally stored electronic expense report 316 and/or a user computer 102 may create an expense report at step 318 having one or more expense lines that are created in the report as shown at step 320. Step 318 can include automatically associating the expense report with the expense pre-approval 306 that was approved at step 312.

Furthermore, after approval of the expense pre-approval 306 at step 312, asynchronously with respect to other flows in FIG. 3, control can transfer to a payment application 326 to create a pay pre-expense record in the database and issue a virtual card, as shown at step 328, resulting in creating a virtual card 338 having a virtual card number 340, which can be displayed initially in a masked or partly obscured format.

At step 314, also asynchronously, the process is programmed to receive a command or request to provide a digital view of the virtual card. In an embodiment, at step 330 the process executes a show virtual card operation, resulting in displaying a virtual card number 342. In an embodiment, a two-factor authentication step may be required from the user to view the virtual card. As noted by the designation “Mobile,” flows after step 314 in FIG. 3 can be accessed and processed using a mobile computing device as the user computer 102.

At an arbitrary time after the virtual card 338 is created, a user computer 102 may present or use the card at step 344. In response, process 300 is programmed at step 332 to populate charges to the card to an expense line that had been created at step 320. These steps may repeat for any number of expense lines in expense report 316.

The expense report 316 can be submitted for approval at step 322 and can receive approval for payment at step 324. In one embodiment, at step 322, expense reconciliation line items are created to accomplish credit line account reconciliation. In an embodiment, a new importer component “virtualcardchargeimporter” may be used to import the functionality of virtual cards on corporate cards. Similar to virtual card reconciliation, expense reconciliation line items may be generated for corporate card charges. In an embodiment, the reconciliation line items may be generated in the form of an expense line table.

In an embodiment, at step 324, upon receiving an indication of expense reconciliation line items, the pre-approval expense charges may be approved for payment. In an embodiment, when the expense report is approved for the payment system, payment objects are created. Accordingly, if the expense report with the virtual card-backed pre-approval is approved for payment, an additional expense line for payment may be created with the virtual card total line amount. Control then transfers to a create pay expense operation 336, which is programmed to automatically create and queue a payment processing transaction to any of a plurality of different payment rails. Payment may be processed against the preapproved spending amounts according to the preapproved expense charges approved on the virtual card.

Periodically and asynchronously with respect to the preceding steps, the administrator may access a request that has been archived and cause the process to call the API to cancel the virtual card as depicted in step 334; for example, a cancellation function can be integrated into the GUI. In an embodiment, an action icon may be added to an expense pre-approval data table for an administrator to archive any pre-approval to cancel the virtual card internally.

In an embodiment, for lapsed or canceled virtual cards, the user can request a re-issuance of virtual cards. For example, on the virtual card pre-approval overview page, the user can click on the reissue link to reissue the virtual card. In this context, the new virtual card may contain new card details which will be updated in the expense reports.

### 3.0 EXAMPLE GRAPHICAL USER INTERFACE

FIG. 4 illustrates a portion of a graphical user interface showing the management of virtual card payments on expense reports, according to an embodiment. Each virtual card payment associated with the expense reconciliation line items may be linked with a new virtual icon. For example, in FIG. 4, the GUI 400 is programmed to display a visual icon 407 that is linked to an expense line item 402 titled “expense category” and associated with a preapproved spend/charge of “529.02 USD” for a rideshare service like UBER as indicated by a vendor label 404 and an amount 406. In an embodiment, icon 407 may comprise a corporate card indicator and/or integration icon. The corporate card indicator is associated with the expense category if a reconciliation line item is generated by the corporate card. The integration icon is shown if a reconciliation line item is generated by an integrated third-party application.

In an embodiment, one or more other reconciliation line items with category labels 408, 412, and amounts 410, 414 are associated with an allocation checkbox 409 to allocate expense line items in the expense reports.

In an embodiment, if the user submits the expense report for approval but then uses their virtual card again, the virtual compute instance 108 automatically generates another draft expense report for requesting pre-approval and associates it with the payment of expense charges. Only one expense with virtual cards may be active at a time. In an embodiment, the user can submit expense reports with virtual cards at any point.

FIG. 5 illustrates a portion of a graphical user interface showing all preapproved expenses based on a type of expense document, according to an embodiment. In an example GUI 500, FIG. 5 shows preapproved expense charges that have been applied to a virtual card as indicated by link 502. A plurality of rows 510 indicate different virtual cards with corresponding status values, identifiers of payment gateways, and card numbers 504 that are applied to different transaction types 506 such as a purchase order and invoice type transaction having transaction values 508. In an embodiment, GUI 500 is programmed to receive and process one or more filter commands to filter the transaction type through one or more filter fields 512. For example, the user can choose the transaction type to be purchase order to show all the expenses corresponding to the purchase order type transactions, incurred on the virtual cards.

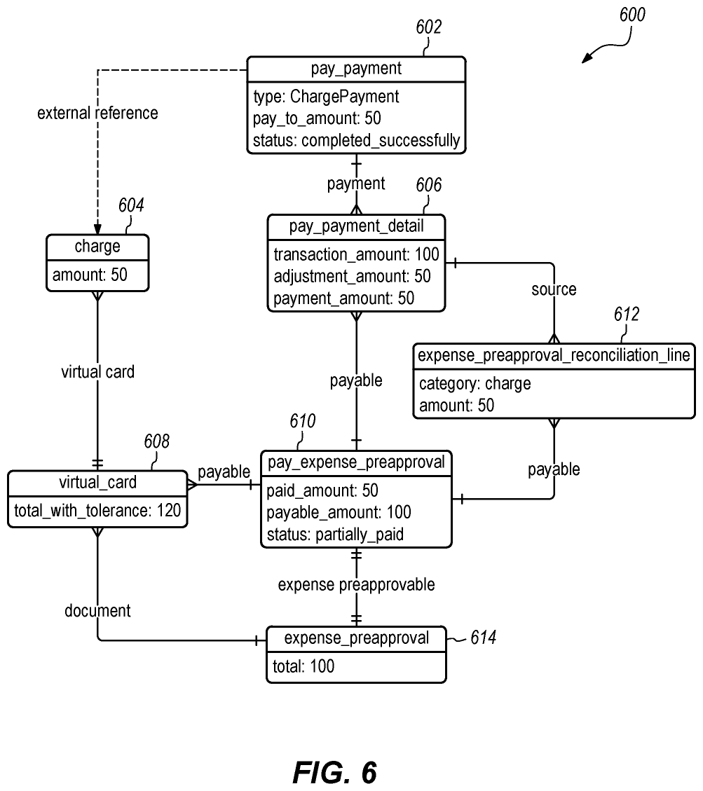

FIG. 6 illustrates a schema of programmatic objects for expense pre-approval and pay expense pre-approval, according to an embodiment. In an embodiment, the system can be programmed according to a class hierarchy or object schema comprising payment objects, expense pre-approval objects, expense pre-approval reconciliation line objects, charge objects, virtual card objects, and others. Object-oriented programming environments like Java, C++, Objective-C, or others can be used in various embodiments.

In an embodiment, an object schema 600 comprises a pay_payment object 602 that can represent a payment of a card charge with object attributes comprising a type, amount, and status value. The pay_payment object 602 externally references a charge object 604 having an amount attribute, which is linked to a virtual card object 608 having a total with tolerance attribute. The virtual card object 608 is linked to an expense_preapproval object 614 having a total value attribute.

The expense_preapproval object 614 is instantiated when a pay_expense_preapproval object 610 has been designated as “expense preapprovable.” The pay_expense_preapproval object 610 can have a paid amount attribute, payable amount attribute, and partially_paid attribute. The pay_expense_preapproval object 610 is referenced from an expense_preapproval_reconciliation_line object 612 having a category attribute and amount attribute, and from a pay_payment_detail object 606 having a transaction amount attribute, an adjustment amount attribute, and a payment amount attribute. The pay_payment_detail object 606 references the pay_payment object 602.

The objects of FIG. 6 can have many attributes other than those shown in FIG. 6, which indicate a minimum set of attributes. FIG. 6 shows multiple payables for a single document, all having separate virtual cards. In an embodiment, multiple pay_expense instances may be achieved for a single expense report. For example, in the case of an expense report partially paid through an expense pre-approval with a virtual card, two pay_expense instances may be generated instead of one. One pay_expense instance may involve holding the remaining amount to pay and the second one with the already reimbursed amount.

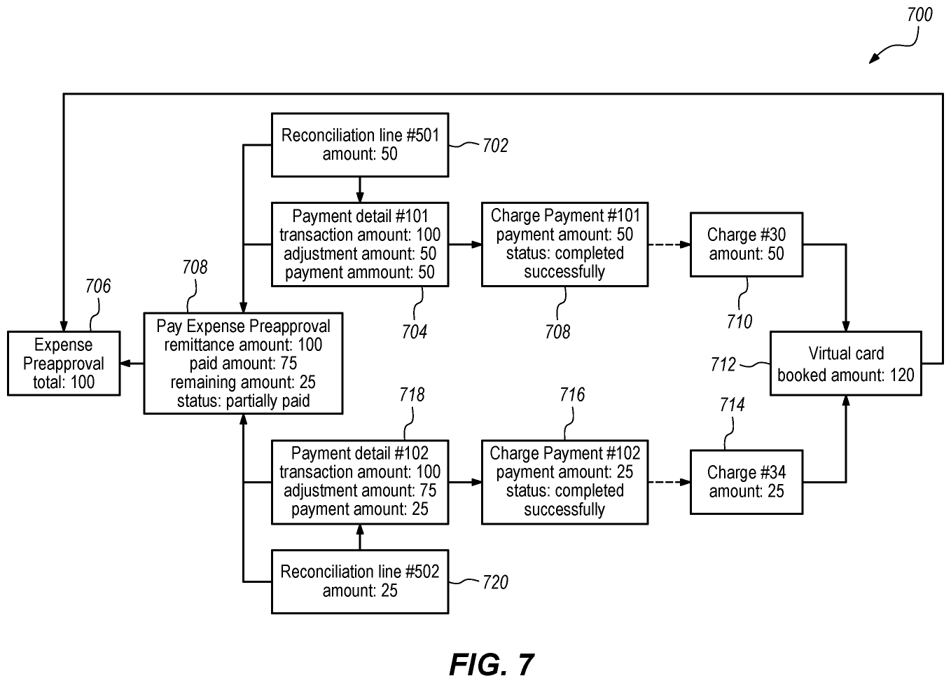

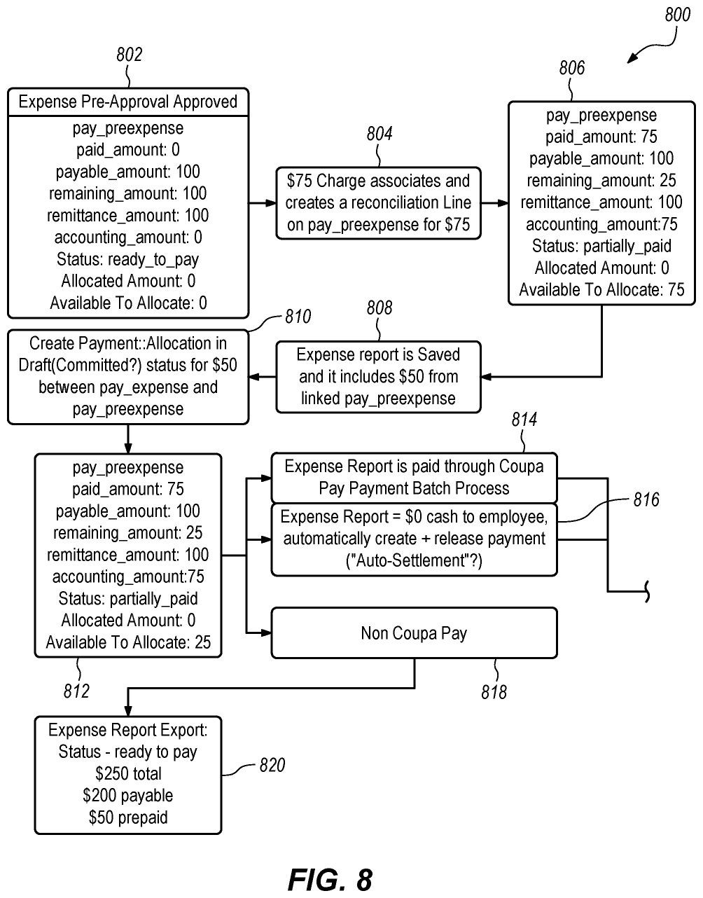

FIG. 7 illustrates a flow of digital data to accomplish the automatic reconciliation of virtual card charges to expense preapprovals, according to an embodiment. Assume that an expense pre-approval 706 in digital database storage has a limit or total attribute of “100.” Assume further that virtual card 712, having a charge limit of “120,” has been used for charges 710, 714 with amounts of “50” and “25,” respectively. The first charge 710 is referenced by a first charge payment object 708 having an identifier of “101,” an amount of “50,” and a status value. The first charge payment object 708 is referenced by a first payment detail object 704, to which a first reconciliation line 702 points.

Similarly, the second charge 714 is referenced by a second charge payment object 716 having an identifier of “102,” an amount of “25,” and a status value. The second charge payment object 716 is referenced by a second payment detail object 718, to which a second reconciliation line 702 points. Both reconciliation lines 702, 720 and payment detail objects 704, 718 reference a pay expense pre-approval object 708, which points to the expense pre-approval object 706.

With this architecture, virtual card charges can be associated and automatically reconciled against an expense pre-approval using programmatic data flows, calls, and object operations, without manual reconciliation and with greater speed, efficiency, and accuracy than has been possible with other manual or technical approaches.

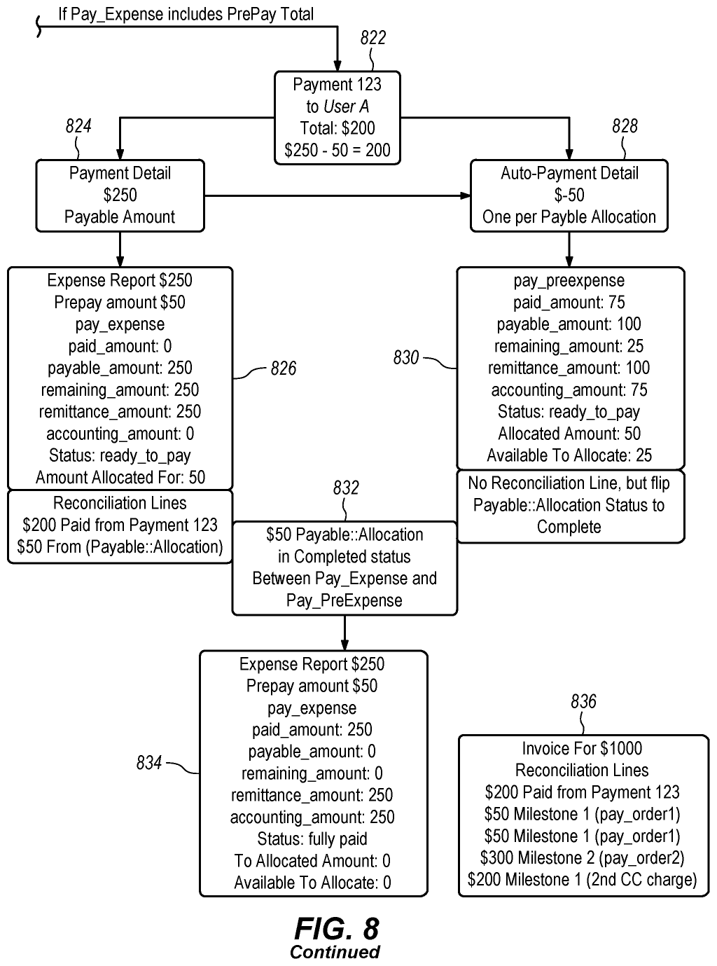

FIG. 8 illustrates an example of the automatic allocation of payments for pre-approved expenses, expense reports, and expense report lines, via the creation of multiple programmatic objects, according to an embodiment. Assume that the operations previously described herein have been used to create and store an expense pre-approval that is approved 802, having the attributes and attribute values shown in FIG. 8, including a payable_amount and remaining_amount of “100.” The data structure is provided in step 804 in which a charge of “$75” associates and creates a reconciliation line in a pay_preexpense object 806.

The pay_preexpense object 806 signals step 808 in which an expense report is saved and includes $50 from the linked pay_preexpense object.

At block 810, the process creates a payment allocation in Draft status for $50, the allocation being between the first pay_expense object 806 and a second pay_preexpense object 812.

Blocks 814, 816 and 818 show different ways of payment disbursements. In one embodiment, at block 814, the expense report is paid through a payment batch process. In another alternative, where the expense report specifies a $0 payment to an employee, the process can be programmed to automatically create and release a payment to another party. With these alternatives, if the pay_expense attribute includes a pre-pay total, then the process is programmed to create and store a payment object 822 representing a particular payment of a particular amount to a particular user.

The payment object 822 can be programmatically transferred to two later flows. In a first flow, at step 824, payment detail data is received to specify a total payable amount and an expense report object 826 is updated, including reconciliation lines. In the example, the $200 paid from payment object 822 includes an allocation of $50. In a second flow, at block 828, automatic payment detail data is created and stored; for example, an automatic payment of $50 in one increment per payable allocation can be provided and routed to the pay_preexpense object 830. This object has no reconciliation line, but cases changing the payable allocation status to “Complete.”

In either flow, at block 832, the $50 allocation will be in the Completed status for the pay_expense and pay_preexpense objects. Thereafter, the process can be programmed to update expense report 834 to show the prepay amount and paid amount values. The process also can be programmed to associate a plurality of reconciliation lines with invoice 836; in an embodiment, the reconciliation lines or pointers to them are stored as attributes of the invoice, enabling immediate visualization or reading of which specific multiple reconciled payments correspond to and have paid the invoice.

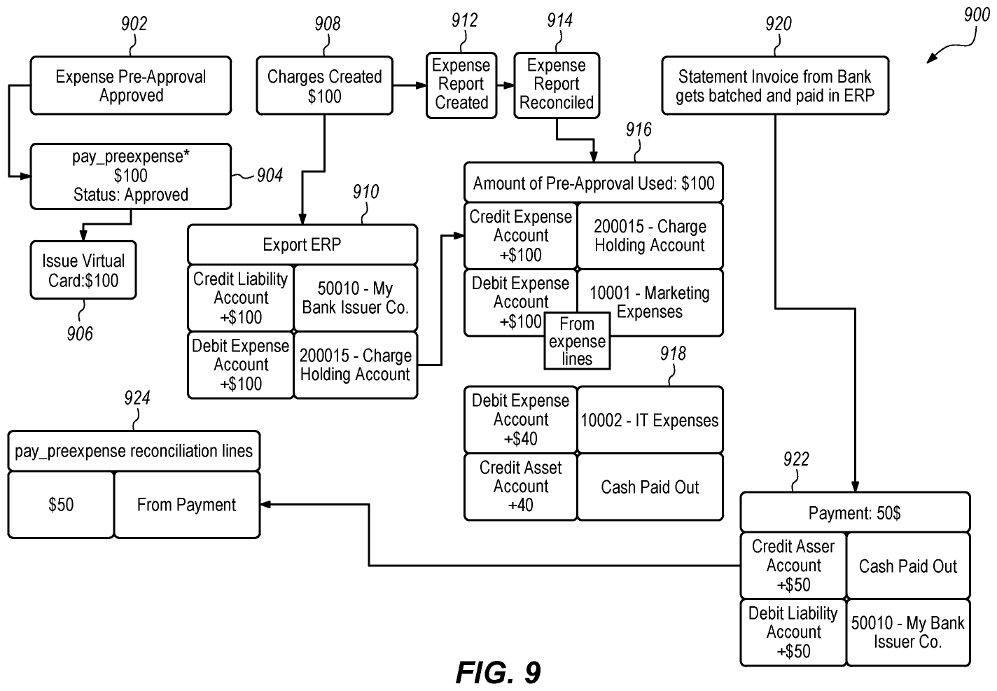

FIG. 9 illustrates an example of programmatic data flows relating to automated reconciliation against an ERP system. As an example, assume that an expense pre-approval has been approved as indicated in block 902. In response, a pay_preexpense object 904 moves to a status of Approved; assume its value attribute is $100. The system can be programmed to issue a virtual card having a limit of $100 in response to the approval, as shown in block 906.

Assume next that one or more charges are created using the virtual card, as shown in block 908. In the first asynchronous operation, at block 910, the process can be programmed to export data to an ERP. Exported data can comprise corresponding and offsetting credit and debit entries, with associated descriptive data for an account to be credited and an account to be charged. At the same time or at a different time, at block 912, an expense report is generated and can be reconciled at block 914. Reconciliation at block 914 can include creating and transmitting records 916, 918 reflecting the amount of pre-approval used, to further update the ERP system; the records can include corresponding and offsetting credit and debit entries, with associated descriptive data for an account to be credited and an account to be charged, based on expense lines of the expense report.

Assume further that at block 920 the user computer 102 or system 100 receives a statement from a bank or an invoice is batched and paid via the ERP system. A payment through the ERP system can cause transmitting a payment object 922 with data from the ERP system specifying an account that was debited for funds for the payment and credited as paid. The payment object 922 can be used programmatically to update one or more pay_preexpense reconciliation line objects 924 with the payment amount and the source of payment.

### 4.0 IMPLEMENTATION EXAMPLE—HARDWARE OVERVIEW

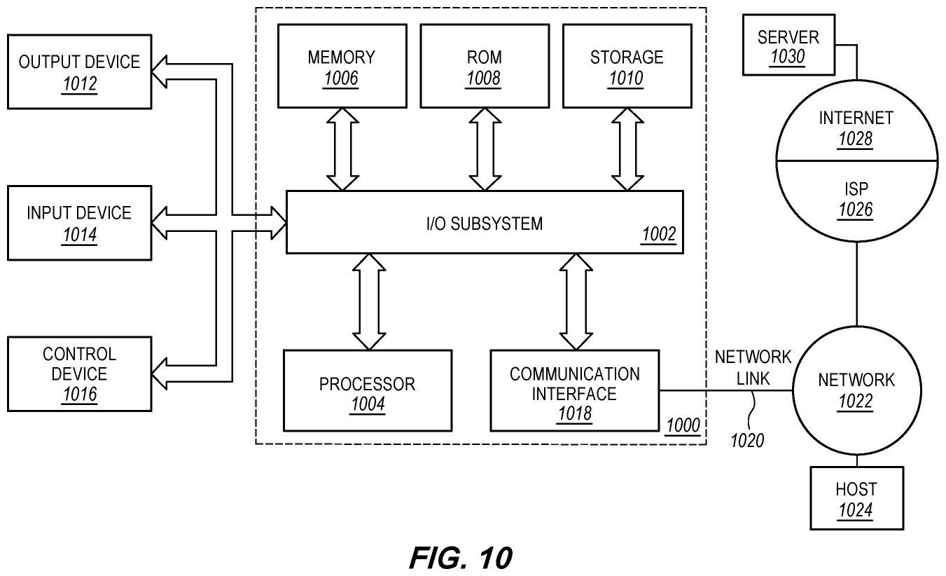

FIG. 10 is a block diagram that illustrates an example computer system with which an embodiment may be implemented. In the example of FIG. 10, a computer system 1000 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 1000 includes an input/output (I/O) subsystem 1002 which may include a bus and/or other communication mechanisms (s) for communicating information and/or instructions between the components of the computer system 1000 over electronic signal paths. The I/O subsystem 1002 may include an I/O controller, a memory controller, and at least one I/O port. The electronic signal paths are represented schematically in the drawings, for example as lines, unidirectional arrows, or bidirectional arrows.

At least one hardware processor 1004 is coupled to I/O subsystem 1002 for processing information and instructions. Hardware processor 1004 may include, for example, a general-purpose microprocessor or microcontroller and/or a special-purpose microprocessor such as an embedded system or a graphics processing unit (GPU), or a digital signal processor or ARM processor. Processor 1004 may comprise an integrated arithmetic logic unit (ALU) or may be coupled to a separate ALU.

Computer system 1000 includes one or more units of memory 1006, such as a main memory, which is coupled to I/O subsystem 1002 for electronically digitally storing data and instructions to be executed by processor 1004. Memory 1006 may include volatile memory such as various forms of random-access memory (RAM) or other dynamic storage devices. Memory 1006 also may be used for storing temporary variables or other intermediate information during the execution of instructions to be executed by processor 1004. Such instructions, when stored in non-transitory computer-readable storage media accessible to processor 1004, can render computer system 1000 into a special-purpose machine that is customized to perform the operations specified in the instructions.

Computer system 1000 further includes non-volatile memory such as read-only memory (ROM) 1008 or other static storage devices coupled to I/O subsystem 1002 for storing information and instructions for processor 1004. The ROM 10010 may include various forms of programmable ROM (PROM) such as erasable PROM (EPROM) or electrically erasable PROM (EEPROM). A unit of persistent storage 1010 may include various forms of non-volatile RAM (NVRAM), such as FLASH memory, solid-state storage, magnetic disk, or optical disks such as CD-ROM or DVD-ROM and may be coupled to I/O subsystem 1002 for storing information and instructions. Storage 1010 is an example of a non-transitory computer-readable medium that may be used to store instructions and data which when executed by the processor 1004 causes performing computer-implemented methods to execute the techniques herein.

The instructions in memory 1006, ROM 1008 or storage 1010 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer such as a relational database system using a structured query language (SQL) or no SQL, an object store, a graph database, a flat file system, or other data storage.

Computer system 1000 may be coupled via I/O subsystem 1002 to at least one output device 1012. In one embodiment, output device 1012 is a digital computer display. Examples of a display that may be used in various embodiments include a touchscreen display or a light-emitting diode (LED) display or a liquid crystal display (LCD) or an e-paper display. Computer system 1000 may include other type(s) of output devices 1012, alternatively or in addition to a display device. Examples of other output devices 1012 include printers, ticket printers, plotters, projectors, sound cards or video cards, speakers, buzzers or piezoelectric devices or other audible devices, lamps or LED or LCD indicators, haptic devices, actuators, or servos.

At least one input device 1014 is coupled to I/O subsystem 1002 for communicating signals, data, command selections, or gestures to processor 1004. Examples of input devices 1014 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 1016, which may perform cursor control or other automated control functions such as navigation in a graphical interface on a display screen, alternatively or in addition to input functions. Control device 1016 may be a touchpad, a mouse, a trackball, or cursor direction keys for communicating direction information and command selections to processor 1004 and for controlling cursor movement on display 1012. The input device may have at least two degrees of freedom in two axes, a first axis (for example, x) and a second axis (for example, y), that allows the device to specify positions in a plane. Another type of input device is a wired, wireless, or optical control device such as a joystick, wand, console, steering wheel, pedal, gearshift mechanism, or other types of control device. An input device 1014 may include a combination of multiple different input devices, such as a video camera and a depth sensor.

In another embodiment, computer system 1000 may comprise an Internet of things (IoT) device in which one or more of the output device 1012, input device 1014, and control device 1016 are omitted. Or, in such an embodiment, the input device 1014 may comprise one or more cameras, motion detectors, thermometers, microphones, seismic detectors, other sensors or detectors, measurement devices or encoders, and the output device 1012 may comprise a special-purpose display such as a single-line LED or LCD display, one or more indicators, a display panel, a meter, a valve, a solenoid, an actuator or a servo.

When computer system 1000 is a mobile computing device, input device 1014 may comprise a global positioning system (GPS) receiver coupled to a GPS module that is capable of triangulating to a plurality of GPS satellites, determining and generating geo-location or position data such as latitude-longitude values for a geophysical location of the computer system 1000. An output device 1012 may include hardware, software, firmware, and interfaces for generating position reporting packets, notifications, pulse or heartbeat signals, or other recurring data transmissions that specify a position of the computer system 1000, alone or in combination with other application-specific data, directed toward host 1024 or server 1030.

Computer system 1000 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 1000 in response to processor 1004 executing at least one sequence of at least one instruction contained in main memory 1006. Such instructions may be read into main memory 1006 from another storage medium, such as storage 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 1010. Volatile media includes dynamic memory, such as memory 1006. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire, and fiber optics, including the wires that comprise a bus of I/O subsystem 1002. Transmission media can also take the form of acoustic or light waves, such as those generated during radio-wave and infrared data communications.

Various forms of media may be involved in carrying at least one sequence of instructions to processor 1004 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 1000 can receive the data on the communication link and convert the data to a format that can be read by computer system 1000. For example, a receiver such as a radio frequency antenna or an infrared detector can receive the data carried in a wireless or optical signal and appropriate circuitry can provide the data to I/O subsystem 1002 such as placing the data on a bus. I/O subsystem 1002 carries the data to memory 1006, from which processor 1004 retrieves and executes the instructions. The instructions received by memory 1006 may optionally be stored on storage 1010 either before or after execution by processor 1004.

Computer system 1000 also includes a communication interface 1018 coupled to bus 1002. Communication interface 1018 provides a two-way data communication coupling to network link(s) 1020 that are directly or indirectly connected to at least one communication networks, such as a network 1022 or a public or private cloud on the Internet. For example, communication interface 1018 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 1022 broadly represents a local area network (LAN), wide-area network (WAN), campus network, internetwork, or any combination thereof. Communication interface 1018 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 1018 sends and receives electrical, electromagnetic, or optical signals over signal paths that carry digital data streams representing various types of information.

Network link 1020 typically provides electrical, electromagnetic, or optical data communication directly or through at least one network to other data devices, using, for example, satellite, cellular, Wi-Fi, or BLUETOOTH technology. For example, network link 1020 may provide a connection through network 1022 to a host computer 1024.

Furthermore, network link 1020 may provide a connection through network 1022 or to other computing devices via internetworking devices and/or computers that are operated by an Internet Service Provider (ISP) 1026. ISP 1026 provides data communication services through a worldwide packet data communication network represented as Internet 1028. A server computer 1030 may be coupled to Internet 1028. Server 1030 broadly represents any computer, data center, virtual machine, or virtual computing instance with or without a hypervisor or computer executing a containerized program system such as DOCKER or KUBERNETES. Server 1030 may represent an electronic digital service that is implemented using more than one computer or instance and that is accessed and used by transmitting web services requests, uniform resource locator (URL) strings with parameters in HTTP payloads, API calls, app services calls, or other service calls. Computer system 1000 and server 1030 may form elements of a distributed computing system that includes other computers, a processing cluster, server farm or other organization of computers that cooperate to perform tasks or execute applications or services. Server 1030 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 1030 may comprise a web application server that hosts a presentation layer, application layer and data storage layer such as a relational database system using a structured query language (SQL) or no SQL, an object store, a graph database, a flat file system, or other data storage.

Computer system 1000 can send messages and receive data and instructions, including program code, through the network(s), network link 1020, and communication interface 1018. In the Internet example, server 1030 might transmit a requested code for an application program through Internet 1028, ISP 1026, local network 1022, and communication interface 1018. The received code may be executed by processor 1004 as it is received, and/or stored in storage 1010, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening several instances of the same program often means more than one process is being executed. Multitasking may be implemented to allow multiple processes to share processor 1004. While each processor 1004 or core of the processor executes a single task at a time, computer system 1000 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method executed using a virtual compute instance executing one or more sequences of expense management instructions, the virtual compute instance communicatively coupled to a storage device comprising a database, the method comprising:
querying an expense pre-approval application to obtain a set of expense documents from a first computer associated with a first account that is digitally linked to a credit line account, and receiving the set of expense documents, the expense pre-approval application being one of a plurality of federated applications hosted using a multi-tenant distributed computing system that comprises the virtual compute instance;
determining, for each document in the set of expense documents, expense data comprising a type of expense document, time of spend, kind of expense, and a plurality of expense charges;
based on the type of document of each expense document in the set of expense documents, identifying a payment gateway among a plurality of payment gateways, each payment gateway executing a plurality of programmatic payment rails that the first account can access;
using the payment gateway, evaluating preapproved expense charges based on the expense data;
creating and storing in the database, a plurality of expense payment objects associated with the preapproved expense charges when a first account database table associated with the credit line account of the first account matches with a second account database table of the payment gateway, and automatically applying the plurality of expense payment objects to reduce account balances of one or more preapproved spending amounts.

2. The method of claim 1, further comprising:
automatically generating a plurality of expense reports for each category of the preapproved expense charges;
presenting a report link for each expense report.

3. The method of claim 2, further comprising:
receiving an incoming charge having an incoming charge amount;
applying, in parallel to the generation of the plurality of expense reports for each category, the incoming charge with the charge amount to the plurality of expense payment objects, and reducing the preapproved expense charges with the charge amount;
creating, in the expense report, reconciliation line items indicating the charge amount for credit line account reconciliation.

4. The method of claim 1, further comprising:
receiving, from the first computer communicatively coupled to the virtual compute instance, a request for creating expense payment objects;
determining whether the credit line account of the first account is specified with a threshold percentage and a threshold amount of credit spend amount;
determining a type of the credit line account corresponding to the first account;
automatically customizing the expense pre-approval application with one or more payment type fields based on the type of credit line account and the threshold amount of credit spend amount.

5. The method of claim 1, further comprising associating each expense payment object with a virtual card account.

6. The method of claim 1, further comprising determining the expense data from each of a plurality of document line items, document line strings, document texts, and document descriptions corresponding to expense documents in the set of expense documents.

7. The method of claim 1, further comprising:
associating each expense payment object with preapproved data that comprises a particular validity period, a particular tolerance limit, a spend amount, and currency of spend linking to the preapproved expense charges;
causing to display, a digital view of the expense payment object of a virtual card account with the preapproved data;
notifying the first computer with the digital view of the expense payment object for viewing and using to charge against preapproved items accredited to the credit line account.

8. The method of claim 1, further comprising identifying expense corporate card account data when an expense payment object is of corporate card type.

9. A server computer, comprising:
one or more processors;
one or more non-transitory computer-readable media coupled to the one or more processors and storing one or more sequences of stored program instructions which when executed using the one or more processors of the server computer, the server computer comprising a virtual compute instance and communicatively coupled to a storage device comprising a database, cause the server computer to perform:
querying an expense pre-approval application to obtain a set of expense documents from a first computer associated with a first account that is digitally linked to a credit line account, and receiving the set of expense documents, the expense pre-approval application being one of a plurality of federated applications hosted using a multi-tenant distributed computing system that comprises the virtual compute instance;
determining, for each document in the set of expense documents, expense data comprising a type of expense document, time of spend, kind of expense, and a plurality of expense charges;
based on the type of document of each expense document in the set of expense documents, identifying a payment gateway among a plurality of payment gateways, each payment gateway executing a plurality of programmatic payment rails that the first account can access;
using the payment gateway, evaluating preapproved expense charges based on the expense data;
creating and storing in the database, a plurality of expense payment objects associated with the preapproved expense charges when a first account database table associated with the credit line account of the first account matches with a second account database table of the payment gateway, and automatically applying the plurality of expense payment objects to reduce account balances of one or more preapproved spending amounts.

10. The server computer of claim 9, further comprising sequences of stored program instructions which when executed using the one or more processors cause the server computer to perform:
automatically generating a plurality of expense reports for each category of the preapproved expense charges;
presenting a report link for each expense report.

11. The server computer of claim 10, further comprising sequences of stored program instructions which when executed using the one or more processors cause the server computer to perform:
receiving an incoming charge having an incoming charge amount;
applying, in parallel to the generation of the plurality of expense reports for each category, the incoming charge with the charge amount to the plurality of expense payment objects, and reducing the preapproved expense charges with the charge amount;
creating, in the expense report, reconciliation line items indicating the charge amount for credit line account reconciliation.

12. The server computer of claim 9, further comprising sequences of stored program instructions which when executed using the one or more processors cause the server computer to perform:
receiving, from the first computer communicatively coupled to the server computer, a request for creating expense payment objects;
determining whether the credit line account of the first account is specified with a threshold percentage and a threshold amount of credit spend amount;
determining a type of the credit line account corresponding to the first account;
automatically customizing the expense pre-approval application with one or more payment type fields based on the type of credit line account and the threshold amount of credit spend amount.

13. The server computer of claim 9, further comprising sequences of stored program instructions which when executed using the one or more processors cause the server computer to perform:
associating each expense payment object with a virtual card account.

14. The server computer of claim 9, further comprising sequences of stored program instructions which when executed using the one or more processors cause the server computer to perform:
determining the expense data from each of a plurality of document line items, document line strings, document texts, and document descriptions corresponding to expense documents in the set of expense documents.

15. The server computer of claim 9, further comprising sequences of stored program instructions which when executed using the one or more processors cause the server computer to perform:
associating each expense payment object with preapproved data that comprises a particular validity period, a particular tolerance limit, a spend amount, and currency of spend linking to the preapproved expense charges;
causing to display, a digital view of the expense payment object of a virtual card account with the preapproved data;
notifying the first computer with the digital view of the expense payment object for viewing and using to charge against preapproved items accredited to the credit line account.

16. The server computer of claim 9, further comprising sequences of stored program instructions which when executed using the one or more processors cause the server computer to perform:
identifying expense corporate card account data when an expense payment object is of corporate card type.

17. One or more non-transitory computer-readable storage media storing one or more sequences of instructions which, when executed using one or more processors of a server computer, the server computer communicatively coupled to a storage device comprising a database, cause the server computer to perform:
querying an expense pre-approval application to obtain a set of expense documents from a first computer associated with a first account that is digitally linked to a credit line account, and receiving the set of expense documents, the expense pre-approval application being one of a plurality of federated applications hosted using a multi-tenant distributed computing system that comprises the virtual compute instance;
determining, for each document in the set of expense documents, expense data comprising a type of expense document, time of spend, kind of expense, and a plurality of expense charges;
based on the type of document of each expense document in the set of expense documents, identifying a payment gateway among a plurality of payment gateways, each payment gateway executing a plurality of programmatic payment rails that the first account can access;
using the payment gateway, evaluating preapproved expense charges based on the expense data;
creating and storing in the database, a plurality of expense payment objects associated with the preapproved expense charges when a first account database table associated with the credit line account of the first account matches with a second account database table of the payment gateway, and automatically applying the plurality of expense payment objects to reduce account balances of one or more preapproved spending amounts.

18. The one or more non-transitory computer-readable storage media of claim 17, further comprising sequences of instructions which, when executed using the one or more processors, cause the server computer to perform:
automatically generating a plurality of expense reports for each category of the preapproved expense charges;
presenting a report link for each expense report.

19. The one or more non-transitory computer-readable storage media of claim 18, further comprising sequences of instructions which, when executed using the one or more processors, cause the server computer to perform:
receiving an incoming charge having an incoming charge amount;
applying, in parallel to the generation of the plurality of expense reports for each category, the incoming charge with the charge amount to the plurality of expense payment objects, and reducing the preapproved expense charges with the charge amount;
creating, in the expense report, reconciliation line items indicating the charge amount for credit line account reconciliation.

20. The one or more non-transitory computer-readable storage media of claim 17, further comprising sequences of instructions which, when executed using the one or more processors, cause the server computer to perform:
receiving, from the first computer communicatively coupled to the virtual compute instance, a request for creating expense payment objects;
determining whether the credit line account of the first account is specified with a threshold percentage and a threshold amount of credit spend amount;
determining a type of the credit line account corresponding to the first account;
automatically customizing the expense pre-approval application with one or more payment type fields based on the type of credit line account and the threshold amount of credit spend amount.

21. The one or more non-transitory computer-readable storage media of claim 17, further comprising sequences of instructions which, when executed using the one or more processors, cause the server computer to perform:
associating each expense payment object with a virtual card account.

22. The one or more non-transitory computer-readable storage media of claim 17, further comprising sequences of instructions which, when executed using the one or more processors, cause the server computer to perform:
determining the expense data from each of a plurality of document line items, document line strings, document texts, and document descriptions corresponding to the expense document.

23. The one or more non-transitory computer-readable storage media of claim 17, further comprising sequences of instructions which, when executed using the one or more processors, cause the server computer to perform:
associating each expense payment object with preapproved data that comprises a particular validity period, a particular tolerance limit, a spend amount, and currency of spend linking to the preapproved expense charges;
causing to display, a digital view of the expense payment object of a virtual card account with the preapproved data;
notifying the first computer with the digital view of the expense payment object for viewing and using to charge against preapproved items accredited to the credit line account.
